(19) United States
(12) Patent Application Publication
(10) Pub. No.: US 2025/0112750 A1
(43) Pub. Date: Apr. 3, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN)

(21) Appl. No.: 18/977,701

(22) Filed: Dec. 11, 2024

Related U.S. Application Data
(63) Continuation of application No. PCT/CN2022/110561, filed on Aug. 5, 2022.

(51) Int. Cl. H04L 5/00; H04L 1/18

(52) U.S. Cl. CPC H04L 5/0094; H04L 1/18

(57) ABSTRACT

A wireless communication method, a terminal device, and a network device are provided in embodiments of the disclosure. The method includes the following. First signaling is received from a network device, where the first signaling is used to configure a first transmission scheme. A second transmission scheme of first information is determined according to the first transmission scheme and the number of at least one spatial parameter associated with the first information. The first information is sent to the network device or received from the network device according to the second transmission scheme.

### CROSS REFERENCE TO RELATED APPLICATION(S)

This application is a continuation of International Application No. PCT/CN2022/110561, filed Aug. 5, 2022, the entire disclosure of which is incorporated herein by reference.

### TECHNICAL FIELD

Embodiments of the disclosure relate to the field of communication, and more specifically to a wireless communication method, a terminal device, and a network device.

### BACKGROUND

In the related art, a network device can configure for a terminal device a transmission scheme to be used by the terminal device among multiple schemes, and the terminal device can send a physical uplink shared channel (PUSCH) to the network device based on multiple antenna panels by using the transmission scheme configured by the network device, thereby improving the reliability of data transmission and reducing a transmission delay. However, there are many limitations on application of a configuration mechanism for such a transmission scheme in a new radio (NR) system, which affects and degrades system performance.

Therefore, for a multiple transmission reception point (multi-TRP) transmission scenario, a wireless communication method is urgently needed in this field to improve system performance.

### SUMMARY

In a first aspect, a wireless communication method is provided in the disclosure. The method includes the following. First signaling is received from a network device, where the first signaling is used to configure a first transmission scheme. A second transmission scheme of first information is determined according to the first transmission scheme and the number of at least one spatial parameter associated with the first information. The first information is sent to the network device or received from the network device according to the second transmission scheme.

In a second aspect, a wireless communication method is provided in the disclosure. The method includes the following. A first hybrid scheme is determined, where the first hybrid scheme includes multiple transmission schemes. Second information is sent to a network device or received from the network device according to the first hybrid scheme.

In a third aspect, a terminal device is provided in the disclosure. The terminal device includes a processor, a transceiver, and a memory. The memory is configured to store a computer program. The processor is configured to invoke and execute the computer program stored in the memory, so as to perform the method in the first aspect, the second aspect, or implementations thereof.

In a fourth aspect, a non-transitory computer-readable storage medium is provided in the disclosure. The computer-readable storage medium is configured to store a computer program which causes a computer to perform the method in the first aspect or implementations thereof.

### BRIEF DESCRIPTION OF THE DRAWINGS

FIG. 1 illustrates an example of a 5th generation (5G) communication system provided in embodiments of the disclosure.

FIG. 2 illustrates another example of a 5G communication system provided in embodiments of the disclosure.

FIG. 3 is a schematic diagram illustrating uplink transmission for multiple transmission reception points (TRPs) provided in embodiments of the disclosure.

FIG. 4 is a schematic diagram of a spatial division multiplexing (SDM) scheme provided in embodiments of the disclosure.

FIG. 5 is a schematic diagram of a frequency division multiplexing (FDM) scheme provided in embodiments of the disclosure.

FIG. 6 is a schematic diagram of a single frequency network (SFN) scheme provided in embodiments of the disclosure.

FIG. 7 is a schematic diagram of a time division multiplexing (TDM) scheme provided in embodiments of the disclosure.

FIG. 8 is a schematic flowchart of a wireless communication method at a terminal device side provided in embodiments of the disclosure.

FIG. 9 is another schematic flowchart of a wireless communication method at a terminal device side provided in embodiments of the disclosure.

FIG. 10 and FIG. 11 each illustrate an example of a mapping manner of a first hybrid scheme for a transmission configuration indication (TCI) state provided in embodiments of the disclosure.

FIG. 12 to FIG. 15 each illustrate an example of a mapping manner of a first hybrid scheme for a redundancy version (RV) provided in embodiments of the disclosure.

FIG. 16 is a schematic flowchart of a wireless communication method at a network device side provided in embodiments of the disclosure.

FIG. 17 is a schematic flowchart of a wireless communication method at a network device side provided in embodiments of the disclosure.

FIG. 18 is a schematic block diagram of a terminal device provided in embodiments of the disclosure.

FIG. 19 is a schematic block diagram of a network device provided in embodiments of the disclosure.

FIG. 20 is another schematic block diagram of a terminal device provided in embodiments of the disclosure.

FIG. 21 is another schematic block diagram of a network device provided in embodiments of the disclosure.

FIG. 22 is a schematic block diagram of a communication device provided in embodiments of the disclosure.

FIG. 23 is a schematic block diagram of a chip provided in embodiments of the disclosure.

### DETAILED DESCRIPTION

Technical solutions of embodiments of the disclosure will be described below with reference to the accompanying drawings.

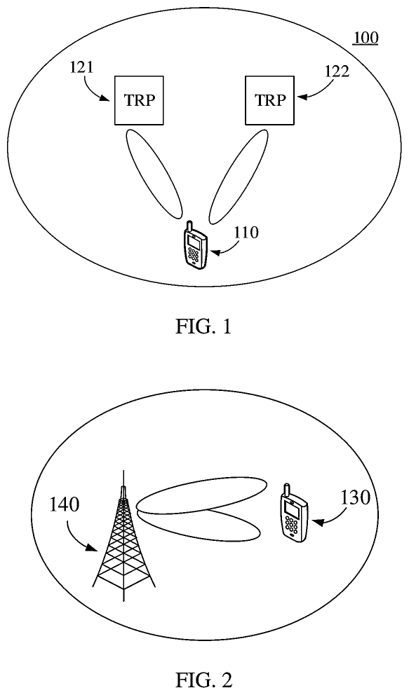

FIG. 1 is an exemplary diagram of a 5th generation (5G) communication system 100 according to embodiments of the disclosure.

As illustrated in FIG. 1, the communication system 100 may include a terminal device 110, a transmission reception point (TRP) 121, and a TRP 122. Each of the TRP 121 and the TRP 122 may communicate with the terminal device 110 via an air interface. Specifically, the TRP 121 and the TRP 122 may separately schedule the terminal device 110 for data transmission. For example, the terminal device 110 detects physical downlink control channels (PDCCHs) from the TRP 121 and the TRP 122 respectively within one slot, the PDCCHs are used to schedule multiple independent uplink data transmissions, and these independent uplink transmissions may be just scheduled into the same slot.

However, in the communication system illustrated in FIG. 1, there may be multiple communication scenarios.

For example, the TRP 121 and the TRP 122 belong to the same cell, and a (backhaul) connection between the TRP 121 and the TRP 122 is ideal, that is, information interaction can be quickly and dynamically performed. For another example, the TRP 121 and the TRP 122 belong to the same cell, and the connection between the TRP 121 and the TRP 122 is non-ideal, that is, information interaction between the TRP 121 and the TRP 122 cannot be quickly performed, and relatively slow data interaction can only be performed. For another example, the TRP 121 and the TRP 122 belong to different cells, and the connection between the TRP 121 and the TRP 122 is ideal. For another example, the TRP 121 and the TRP 122 belong to different cells, and the connection between the TRP 121 and the TRP 122 is non-ideal.

In addition, different new radio (NR)-PDCCHs/NR-physical downlink shared channels (PDSCHs) may be sent from multiple TRPs to the terminal device 110, that is, the terminal device 110 may receive downlink information on multiple downlinks. Here, each downlink has corresponding uplink information to be sent, and the uplink information contains at least one of the following signals: acknowledgement/non-acknowledgement (ACK/NACK) corresponding to each downlink, report information such as channel state information (CSI) corresponding to each downlink, or uplink data. As can be seen, if the terminal device 110 further needs to send uplink information on uplinks corresponding to multiple downlinks, complexity and power consumption of the terminal device will be excessively high. Regarding the above problems, the excessively high complexity and power consumption of the terminal device can be reduced through indicating a transmission mode of an uplink signal for the terminal device 110 by the TRP 121 or the TRP 122.

It may be understood that, the 5G communication system 100 is merely taken as an example for illustration in embodiments of the disclosure, but embodiments of the disclosure are not limited thereto. In other words, the technical solutions of embodiments of the disclosure may be applied to any communication system in which multiple network devices can separately schedule a terminal for data transmission. For example, if TRPs in FIG. 1 correspond to beams, an example of an application scenario illustrated in FIG. 2 may be obtained accordingly. The scenario includes a terminal device 130 and a network device 140, where there are multiple beams between the terminal device 130 and the network device 140.

Examples may be a global system of mobile communication (GSM) system, a code division multiple access (CDMA) system, a wideband code division multiple access (WCDMA) system, a general packet radio service (GPRS), a long term evolution (LTE) system, an LTE time division duplex (TDD) system, a universal mobile telecommunication system (UMTS), and the like.

This disclosure describes various embodiments in combination with the network device and the terminal device.

The network device 140 may refer to any entity at a network side for sending or receiving signals. For example, the network device may be a user equipment (UE) for machine-type communication (MTC), a base transceiver station (BTS) in the GSM or in the CDMA system, a NodeB in the WCDMA system, an evolutional node B (eNB or eNodeB) in the LTE system, a base station device in the 5G network, or the like.

In addition, the terminal device 110 may be any terminal device. Specifically, the terminal device 110 may communicate with one or more core networks through a radio access network (RAN), and may also be referred to as an access terminal, a UE, a subscriber unit, a subscriber station, a mobile station, a remote station, a remote terminal, a mobile device, a user terminal, a terminal, a wireless communication device, a user agent, or a user device. For example, the terminal device may be a cellular phone, a cordless phone, a session initiation protocol (SIP) phone, a wireless local loop (WLL) station, a personal digital assistant (PDA), a handheld device or a computing device with wireless communication functions, other processing devices coupled with a wireless modem, an in-vehicle device, a wearable device, and a terminal device in the 5G network, etc.

For better understanding of the solutions of the disclosure, related content will be described below.

### 1. Unified Transmission Configuration Indication (TCI) State

In the 3rd generation partnership project (3GPP) standardization progress, the concept of a TCI state is put forward in release 15 (Rel. 15), which is used for downlink spatial-domain quasi co-location (QCL) (beam) indication and for transmission of QCL information in a time domain or a frequency domain. Specifically, a QCL relationship may be simply referred to as a large-scale fading relationship from a certain source reference signal to a target reference signal. For the beam indication, after a UE obtains from a network (NW) a QCL relationship between a source reference signal and a target reference signal, the UE can use a previous reception beam that is used for receiving the source reference signal to receive of the target reference signal.

However, an indication mechanism for the TCI state is only applicable to downlink channels and signals, and has many limitations to apply in an NR system. Based on this, in order to provide a more unified uplink and downlink beam management mechanism for the NR system, the concept of the unified TCI state is put forward in 3GPP Rel. 17 based on the design of the TCI state in Rel. 15/16, so as to reduce the beam indication frequency and reduce the resource consumption, thereby improving system performance.

Exemplarily, the unified TCI state may include a joint TCI state, a separate DL TCI state, and a separate UL TCI state. The joint TCI state is applicable to uplink and downlink channels and signals, the separate DL TCI state is only applicable to downlink channels and signals, and the separate UL TCI state is only applicable to uplink channels and signals.

Exemplarily, the same downlink transmission indication beam, i.e., the separate DL TCI state or the joint TCI state, can be used for the downlink channels (part of PDCCHs, PDSCHs) and signals (aperiodic channel state information reference signals (CSI-RSs)). The same uplink transmission beam, i.e., the separate UL TCI state or the joint TCI state, can be used for the uplink channels (physical uplink control channels (PUCCHs), physical uplink shared channels (PUSCHs)) and signals (sounding reference signals (SRSs)).

Exemplarily, the unified TCI state may be dynamically updated and indicated by a medium access control (MAC) control element (CE) and/or downlink control information (DCI).

Downlink and uplink non-coherent transmission based on multiple TRPs has been introduced in the NR system. A backhaul connection between the TRPs may be ideal or non-ideal. In case of an ideal backhaul connection, information interaction between the TRPs can be quickly and dynamically performed, and thus the delay is small. Since information interaction between the TRPs can only be quasi-statically performed in case of a non-ideal backhaul connection, the delay is large. Since different TRPs have different spatial positions, large-scale features of a channel corresponding to each TRP are significantly different. Therefore, for multiple TRP (multi-TRP) joint transmission, QCL information corresponding to each TRP needs to be indicated separately.

Configuration and indication of the TCI state include radio resource control (RRC) configuration, MAC-CE activation, and DCI indication. A terminal is configured with up to M TCI states through PDSCH-Config by RRC, where the value of M is determined according to a UE capability and the maximum value of M may be 128. A maximum of 8 TCI state groups are activated by the MAC-CE to map to 3-bit TCI information fields in the DCI. Each of the TCI state groups activated by the MAC-CE may contain 1 or 2 TCI states. If a higher-layer parameter configures that the DCI contains a TCI indication field, DCI format 1_1 may indicate one TCI state group from the MAC-activated TCI state groups. If the higher-layer parameter configures that the DCI does not contain any TCI indication field or data is scheduled by DCI format 1_0, the DCI will not contain any TCI state-indication field.

A TCI state may contain the following configuration: an identity (ID) of the TCI state, which is used to identify the TCI state; and QCL information 1.

Optionally, the TCI state may further contain QCL information 2.

In the above, the QCL information includes the following information: QCL-type configuration, which may be one of QCL typeA, QCL typeB, QCL typeC, and QCL typeD; and QCL reference-signal configuration, including an ID of a cell where a reference signal is located, a band width part (BWP) ID, and an ID of the reference signal. The ID of the reference signal may be a CSI-RS resource ID or a synchronization signal block (SSB) index.

If QCL information 1 and QCL information 2 are configured, a QCL type of at least one QCL information will be one of QCL typeA, QCL typeB, and QCL typeC, and a QCL type of the other QCL information will be QCL typeD.

In the above, the QCL-type configuration is defined as follows:
‘QCL-TypeA’: {Doppler shift, Doppler spread, average delay, delay spread};
‘QCL-TypeB’: {Doppler shift, Doppler spread};
QCL-TypeC': {Doppler shift, average delay}; and
‘QCL-TypeD’: {Spatial Rx parameter}.

### 2. PDSCH Transmission Schemes for Multiple TRPs

A propagation characteristic of a channel between each of multiple transmission points and a user is relatively independent, and the reliability of data transmission can be improved and the transmission delay can be reduced through multi-TRP repetitions in the spatial domain, time domain, and frequency domain. In case of an ideal backhaul connection, PDSCH transmissions for multiple TRPs can be scheduled by single DCI, and the multiple PDSCH transmissions may be carried out in a frequency division multiplexing (FDM) manner, a spatial division multiplexing (SDM) manner, a time division multiplexing (TDM) manner, and the like. In case of a non-ideal ideal backhaul connection, PDSCH transmissions for multiple TRPs can be scheduled by multiple DCIs, and the multiple PDSCH transmissions may be carried out in an FDM manner, an SDM manner, a TDM manner, and the like.

In other words, the PDSCH transmission schemes for multiple TRPs may specifically include the following two schemes.

Single DCI-multi-PDSCH (sDCI-mPDSCH): the NW uses one DCI to schedule transmission of two PDSCHs, where the DCI is from one of two TRPs, and the NW can dynamically adjust which one of the TRPs to use. The two PDSCHs are sent by the two TRPs in different manners, such as an SDM manner, an FDM manner, and a TDM manner. This scheme is suitable for the case of an ideal backhaul link between the TRPs. In addition, scheduling DCI may contain 1 or 2 TCI states, so as to indicate a dynamic switch between single TRP (sTRP) transmission and multi-TRP (mTRP) transmission. Specifically, when a codepoint of a TCI field in the DCI indicates one TCI state, it indicates the sTRP transmission. When the codepoint indicates two TCI states, it indicates the mTRP transmission, and in this case, each of the TCI states is mapped to a specific resource for the TRP transmission, such as a code division multiplexing (CDM) group, a demodulation reference signal (DMRS) port, the number of transmission layers, a phase-tracking RS (PT-RS) port, a redundancy version (RV), and other contents related to PDSCH scheduling.

Multiple DCI-multi-PDSCH (mDCI-mPDSCH): each TRP independently schedules transmission of a PDSCH by sending a PDCCH, and time-frequency resources for the transmission of the PDSCHs may be completely overlapping, partially overlapping, or completely non-overlapping. This scheme is suitable for the case of no ideal backhaul link between the TRPs.

In addition, a switching method for different transmission schemes includes the following.
a. The DCI indicates two TCI states, and a transmission scheme is configured through RRC signaling as any one of FDM scheme A, FDM scheme B, and TDM scheme A.
b. If the DCI indicates two TCI states and the number of repetitions is configured through repetitionNumber in RRC signaling, the transmission scheme is TDM scheme B.
c. For the dynamic switch of the transmission scheme, the network device can dynamically switch to a non-repetition scheme in R15 through the DCI indicating one TCI state. Alternatively, if the DCI indicates two TCI states and the DCI indicates, through an antenna port field, that the DMRS port is in two CDM groups, the transmission scheme is an SDM scheme;
d. If a base station configures for the PDSCH an RRC parameter repetitionNumber, the UE does not expect to be configured with an RRC parameter repetitionScheme.
e. If the base station configures for the PDSCH the RRC parameter repetitionNumber or the base station configures for the PDSCH the repetitionScheme as ‘fdmSchemeA’ or ‘fdmSchemeB’ or ‘tdmSchemeA’, the UE does not expect to be configured with pdsch-AggregationFactor.
f. It can be understood from the limitations of “d” and “e” that an FDM scheme and a TDM scheme can only be configured separately.

In downlink non-coherent transmission, different control channels may be used by the multiple TRPs to separately schedule multiple PDSCH transmissions for a terminal, or the same control channel may be used to schedule transmission for different TRPs. For example, in case of an ideal backhaul connection, the same control channel may be used to schedule transmission for different TRPs. Specifically, sDCI-scheduled PDSCHs from two TRPs can be distinguished according to the TCI states, that is, the TCI information field in the DCI can be mapped to two TCI states. As such, the network device may use the two TCI states to send the PDSCHs to the terminal device in different transmission schemes.

### 3. PUSCH Transmission Schemes Based on Multiple TRPs.

PUSCHs sent to two TRPs can be sent in a TDM manner. PUSCHs sent by the terminal device to different TRPs align with corresponding TRPs for analog beam forming, that is, different PUSCHs can be distinguished by the spatial domain to provide uplink spectral efficiency. Specifically, the network device may also schedule, by the single DCI or multiple DCIs, the terminal device to send the PUSCHs to the two TRPs. For example, the multiple DCIs may be carried in different control resource sets (CORESETs). Specifically, multiple CORESET groups are configured at a network side, and each TRP uses a CORESET in a respective CORESET group for scheduling, that is, different TRPs can be distinguished according to the CORESET groups. For example, the network device can configure for each CORESET one CORESET group index, where different indexes correspond to different TRPs respectively.

A TDM scheme includes repetition type A and repetition type B. Here, repetition type A may also be referred to as TDM scheme A, and repetition type B may also be referred to as TDM scheme B. A configuration method for repetition type A and repetition type B is that any one of the two schemes is configured by RRC.

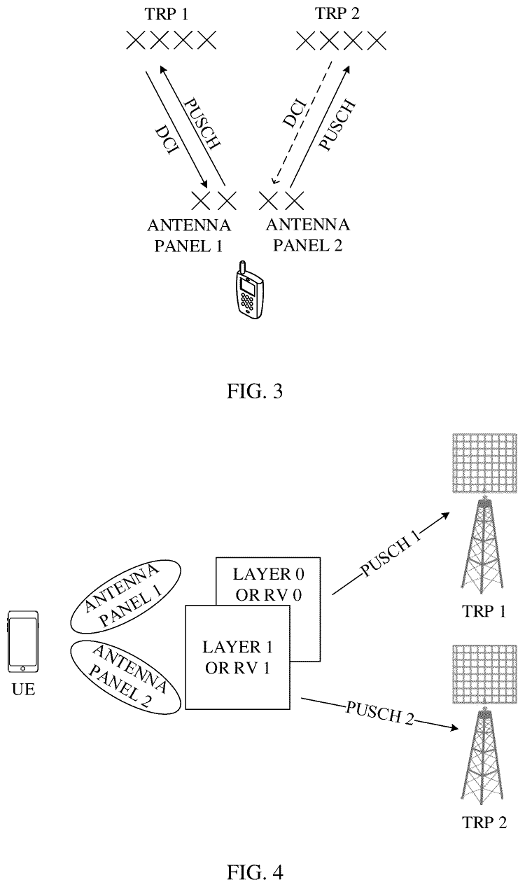

FIG. 3 is a schematic diagram illustrating uplink transmission for multiple TRPs provided in embodiments of the disclosure.

As illustrated in FIG. 3, if the terminal device is configured with multiple antenna panels and supports simultaneous transmission of uplink information to the multiple TRPs on the multiple antenna panels, the terminal device can simultaneously send multiple uplink information to the multiple TRPs on the multiple antenna panels, so as to improve the uplink spectral efficiency. The uplink transmission on the multiple antenna panels may be scheduled by the single DCI or multiple DCIs. For example, the terminal device can send a PUSCH to TRP 2 on antenna panel 2 while sending the PUSCH to TRP 1 on antenna panel 1, so as to improve the spectral efficiency of the PUSCH. The PUSCH from Antenna panel 1 and the PUSCH from antenna panel 2 may be scheduled by the single DCI, such as DCI sent by TRP 1. Alternatively, the PUSCH from antenna panel 1 and the PUSCH from antenna panel 2 may be scheduled by the multiple DCIs, such as the DCI sent by TRP 1 and DCI sent by TRP 2.

### 4. Mapping Manners for RVs in Different Transmission Schemes

For PDSCH transmission schemes for multiple TRPs, RVs corresponding to n=0 and n=1 in the same group of RV patterns are respectively used for two PDSCHs sent in an FDM manner according to FDM scheme B. For repetition type A and repetition type B in the PUSCH transmission schemes for the multiple TRPs, a first group of RV patterns are used for a PUSCH associated with a first SRS resource set, and another group of RV patterns are used for a PUSCH associated with another SRS resource set.

5. System framework for each transmission scheme

In some embodiments, PUSCH 1 and PUSCH 2 are sent in an SDM manner, and a transmission scheme of PUSCH 1 and PUSCH 2 may be referred to as an SDM scheme.

In some embodiments, in an SDM transmission scheme, PUSCH 1 and PUSCH 2 correspond to the same time-frequency resources.

SDM scheme A: different transport-layer sets of target uplink information are associated with different spatial parameters, respectively. For example, a part of transmission layers of the target uplink information is associated with a first spatial parameter, and the part of transmission layers is referred to as first uplink information. Another part of the transmission layers of the target uplink information is associated with a second spatial parameter, and the another part of the transmission layers is referred to as second uplink information.

Specifically, in SDM scheme A, for example, when the target uplink information is a PUSCH and the spatial parameter is a TCI state, different transport-layer sets of the PUSCH can be sent to different TRPs on different antenna panels of the terminal device. For example, different transport-layer sets sent to different TRPs on different antenna panels may be considered to be different PUSCHs or different PUSCH transmission occasions. For example, a part of transmission layers of the PUSCH sent on antenna panel 1 is associated with a first TCI state, which is referred to as PUSCH 1, and another part of transmission layers of the PUSCH sent on antenna panel 2 is associated with a second TCI state, which is referred to as PUSCH 2. It may be understood that, PUSCH 1 and PUSCH 2 are different transmission layers of the same transport block (TB). For example, as illustrated in FIG. 4, PUSCH 1 is a transmission layer layer-0 of the same TB, and PUSCH 2 is a transmission layer layer-1 of the same TB. Of course, in other alternative embodiments, each of PUSCH 1 and PUSCH 2 may also be another transmission layer or several other transmission layers of the same TB, which will not be limited in the disclosure.

SDM scheme B: repetitions of the target uplink information (which may be different RVs) are associated with different spatial parameters. That is, multiple uplink information refers to repetitions of the target uplink information associated with different spatial parameters.

Specifically, in SDM scheme B, taking the target uplink information as a PUSCH for example, repetitions of the PUSCH are sent to different TRPs on different antenna panels of the terminal device. For example, the PUSCH sent on antenna panel 1 of the terminal device is referred to as PUSCH 1, and the PUSCH sent on antenna panel 2 of the terminal device is referred to as PUSCH 2. It may be understood that, PUSCH 1 and PUSCH 2 may be repetitions of the same TB. For example, as illustrated in FIG. 4, PUSCH 1 is RV 0 of the same TB, and PUSCH 2 is RV 1 of the same TB. Of course, in other alternative embodiments, PUSCH 1 and PUSCH 2 may also be other RVs of the same TB, which will not be limited in the disclosure.

In some embodiments, PUSCH 1 and PUSCH 2 are sent in an FDM manner, and a transmission scheme of PUSCH 1 and PUSCH 2 may be referred to as an FDM scheme.

In some embodiments, in an FDM transmission scheme, time-domain resources for PUSCH 1 and PUSCH 2 are the same, and frequency-domain resources for PUSCH 1 and PUSCH 2 are non-overlapping.

FDM scheme A: different parts of the target uplink information are associated with different spatial parameters, respectively. That is, multiple uplink information may be different parts of the target uplink information associated with different spatial parameters.

In FDM scheme A, a TB corresponds to a single PUSCH transmission occasion, and each TCI state is related to allocation of non-overlapping frequency-domain resources.

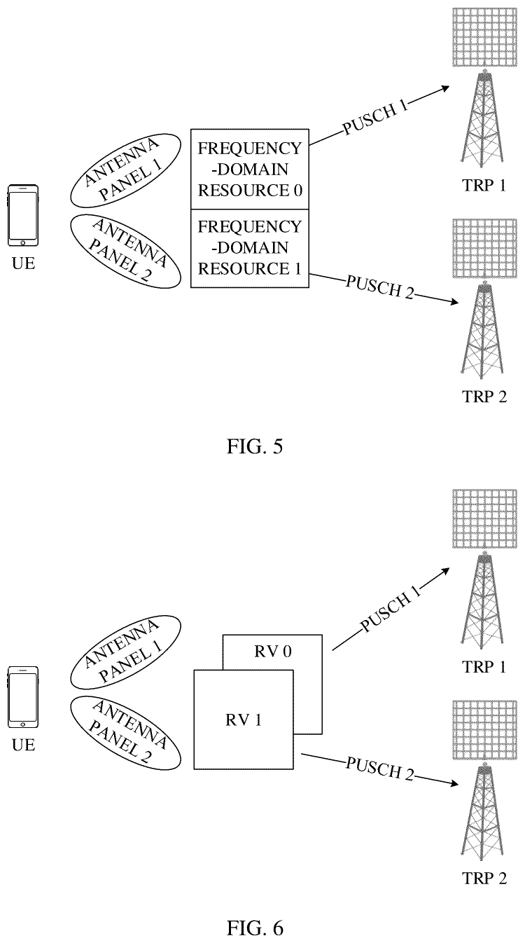

Specifically, in FDM scheme A, taking the target uplink information as a PUSCH for example, different parts (for example, different information bits) of the PUSCH are sent to different TRPs on different antenna panels of the terminal device. For example, a part of the PUSCH sent on antenna panel 1 of the terminal device is referred to as PUSCH 1, and a part of the PUSCH sent on antenna panel 2 of the terminal device is referred to as PUSCH 2. PUSCH 1 and PUSCH 2 both correspond to the same PUSCH transmission occasion. PUSCH 1 and PUSCH 2 are associated with non-overlapping frequency-domain resources, respectively. For example, as illustrated in FIG. 5, a PUSCH transmission occasion of PUSCH 1 is associated with frequency-domain resource 0, a PUSCH transmission occasion of PUSCH 2 is associated with frequency-domain resource 1, and frequency-domain resource 0 does not overlap frequency-domain resource 1.

FDM scheme B: repetitions of the target uplink information (which may be different RVs or the same RV) are associated with different spatial parameters. That is, multiple uplink information refers to repetitions of the target uplink information associated with different spatial parameters.

In FDM scheme B, the same TB corresponds to two PUSCH transmission occasions, each TCI state is associated with one PUSCH transmission occasion, and the two PUSCH transmission occasions have non-overlapping frequency-domain resources.

Specifically, in FDM scheme B, taking the target uplink information as a PUSCH for example, repetitions of the PUSCH are sent to different TRPs on different antenna panels of the terminal device. For example, the PUSCH sent on antenna panel 1 of the terminal device is referred to as PUSCH 1, and the PUSCH sent on antenna panel 2 of the terminal device is referred to as PUSCH 2. PUSCH 1 and PUSCH 2 correspond to two PUSCH transmission occasions, respectively. The two PUSCH transmission occasions of PUSCH 1 and PUSCH 2 are associated with non-overlapping frequency-domain resources, respectively. For example, as illustrated in FIG. 5, a PUSCH transmission occasion of PUSCH 1 is associated with frequency-domain resource 0, a PUSCH transmission occasion of PUSCH 2 is associated with frequency-domain resource 1, and frequency-domain resource 0 does not overlap frequency-domain resource 1.

In some embodiments, PUSCH 1 and/or PUSCH 2 are sent in a single frequency network (SFN) manner, and a transmission scheme of PUSCH 1 and/or PUSCH 2 may be referred to as an SFN scheme.

In some embodiments, in an SFN transmission scheme, time-domain resources for PUSCH 1 and PUSCH 2 are the same, frequency-domain resources for PUSCH 1 and PUSCH 2 are the same, and DMRS ports for PUSCH 1 and PUSCH 2 are also the same.

Exemplarily, in the SFN transmission scheme, repetitions of the target uplink information are associated with different spatial parameters. That is, multiple uplink information refers to repetitions of the target uplink information associated with different spatial parameters. Taking the target uplink information as a PUSCH for example, repetitions of the PUSCH are sent to different TRPs on different antenna panels of the terminal device. For example, as illustrated in FIG. 6, the PUSCH sent on antenna panel 1 of the terminal device is referred to as PUSCH 1, and the PUSCH sent on antenna panel 2 of the terminal device is referred to as PUSCH 2.

In some embodiments, PUSCH 1 and PUSCH 2 are sent in a TDM manner, and a transmission scheme of PUSCH 1 and PUSCH 2 may be referred to as a TDM scheme.

In some embodiments, in a TDM transmission scheme, frequency-domain resources for PUSCH 1 and PUSCH 2 are the same, and time-domain resources for PUSCH 1 and PUSCH 2 are non-overlapping.

Repetition type A (slot-based PUSCH): two groups of PUSCHs (the same RV or different RVs) are sent at the same symbol position in K consecutive slots, and each group of PUSCHs is associated with one TCI state.

In repetition type A, the same TB corresponds to two PUSCH transmission occasions, each TCI state is associated with one PUSCH transmission occasion, and the two PUSCH transmission occasions have non-overlapping time-domain resources at the same symbol position in the K consecutive slots.

Specifically, in repetition type A, taking the target uplink information as a PUSCH for example, repetitions of the PUSCH are sent to different TRPs on different antenna panels of the terminal device. For example, the PUSCH sent on antenna panel 1 of the terminal device is referred to as PUSCH 1, and the PUSCH sent on antenna panel 2 of the terminal device is referred to as PUSCH 2. PUSCH 1 and PUSCH 2 correspond to two PUSCH transmission occasions, respectively. The two PUSCH transmission occasions of PUSCH 1 and PUSCH 2 are associated with non-overlapping time-domain resources, respectively. For example, as illustrated in FIG. 6, a PUSCH transmission occasion of PUSCH 1 is associated with time-domain resource 0, a PUSCH transmission occasion of PUSCH 2 is associated with time-domain resource 1, and time-domain resource 0 and time-domain resource 1 are non-overlapping time-domain resources at the same symbol position in the K consecutive slots.

Repetition type B (mini-slot based PUSCH): two groups of PUSCHs (the same RV or different RVs) are sent in K nominal transmission occasions, and each group of PUSCHs is associated with one TCI state.

In repetition type B, the same TB corresponds to two PUSCH transmission occasions, each TCI state is associated with one PUSCH transmission occasion, and the two PUSCH transmission occasions have non-overlapping time-domain resources in the K nominal transmission occasions.

Specifically, in repetition type B, taking the target uplink information as a PUSCH for example, repetitions of the PUSCH are sent to different TRPs on different antenna panels of the terminal device. For example, the PUSCH sent on antenna panel 1 of the terminal device is referred to as PUSCH 1, and the PUSCH sent on antenna panel 2 of the terminal device is referred to as PUSCH 2. PUSCH 1 and PUSCH 2 correspond to two PUSCH transmission occasions, respectively. The two PUSCH transmission occasions of PUSCH 1 and PUSCH 2 are associated with non-overlapping time-domain resources, respectively. For example, as illustrated in FIG. 6, a PUSCH transmission occasion of PUSCH 1 is associated with time-domain resource 0, a PUSCH transmission occasion of PUSCH 2 is associated with time-domain resource 1, and time-domain resource 0 and time-domain resource 1 are non-overlapping time-domain resources in the K nominal transmission occasions.

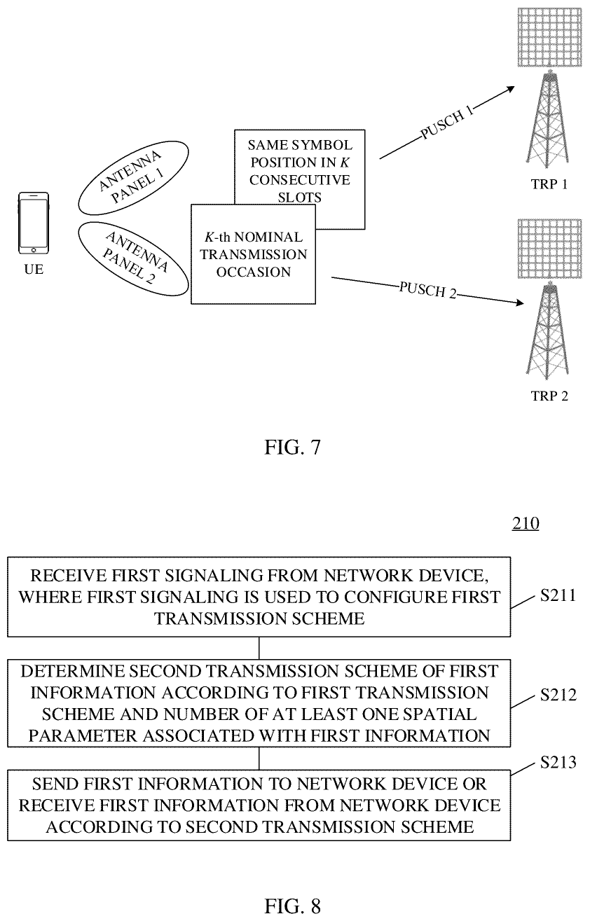

With reference to FIG. 7, at the terminal device, PUSCH 1 sent on antenna panel 1 may be associated with a first TCI state, and PUSCH 2 sent on antenna panel 2 may be associated with a second TCI state. Both PUSCH 1 and PUSCH 2 refer to repetitions of a PUSCH, which may be, for example, the same RV or different RVs for the PUSCH. Time-domain resources for PUSCH 1 and PUSCH 2 are K nominal transmission occasions.

The FDM scheme and TDM scheme only support configuration through RRC signaling. In the SDM scheme, two DMRS CDM groups can only be indicated by an antenna port field in the DCI and be associated with different TCI states, so that the network device can send the PDSCH in an SDM manner. Therefore, there are many limitations on application of a configuration mechanism for such a transmission scheme in an NR system, which affects and degrades system performance.

In view of this, a wireless communication method, a terminal device, and a network device are provided in embodiments of the disclosure, which can improve system performance.

FIG. 8 is a schematic flowchart of a wireless communication method 210 provided in embodiments of the disclosure. The wireless communication method 210 may be performed by a terminal device, for example, the terminal device illustrated in FIG. 1.

As illustrated in FIG. 8, the method 210 may include the following.

At S211, first signaling is received from a network device, where the first signaling is used to configure a first transmission scheme.

At S212, a second transmission scheme of first information is determined according to the first transmission scheme and the number of at least one spatial parameter associated with the first information.

At S213, the first information is sent to the network device or received from the network device according to the second transmission scheme.

Based on the above technical solutions, first signaling is received, and a second transmission scheme of first information is determined according to a first transmission scheme configured by the first signaling and the number of at least one spatial parameter associated with the first information. In this way, the terminal device will not be directly configured with the second transmission scheme through only semi-static signaling or through only dynamic signaling, which is conducive to improving the reliability of data transmission, reducing a data transmission delay, and ensuring the balance of diversity gain, thereby improving system performance.

Exemplarily, the first signaling is used to semi-statically configure the first transmission scheme. For example, the first signaling may be semi-static signaling, and the semi-static signaling includes, but is not limited to, RRC signaling and MAC-CE signaling.

Exemplarily, the first information may be uplink information or downlink information. The “uplink information” may also be equivalent to an “uplink channel”, and the “downlink information” may be equivalent to a “downlink channel”.

Exemplarily, the uplink channel may include a physical random access channel (PRACH), a PUCCH, a PUSCH, and the like. An uplink reference signal may include an uplink DMRS, an SRS, a PT-RS, and the like. The uplink DMRS can be used for of uplink channel demodulation, the SRS can be used for uplink channel measurement, uplink time-frequency synchronization, or phase tracking, and the PT-RS can also be used for uplink channel measurement, uplink time-frequency synchronization, or phase tracking.

It may be understood that, an uplink physical channel or uplink reference signal with different functions and the same name as the above may be included in embodiments of the disclosure, and an uplink physical channel or uplink reference signal with different names and the same function as the above may also be included in embodiments of the disclosure, which will not be limited in the disclosure.

Exemplarily, the spatial parameter includes at least one of: TCI state information, antenna panel information, TRP information, CORESET group information, reference signal set information, capability set information, beam information, or the like. An antenna panel is a logical entity used by the terminal device for transmission, and transmission beams and/or reception beams for antennas on different antenna panels can be independently adjusted.

In some embodiments, the antenna panel information may include an identity (ID) or index of an antenna panel.

In some embodiments, the TRP information may include an ID or index of a TRP.

In some embodiments, the CORESET group information may include an ID or index of a CORESET group.

In some embodiments, the TCI state information may include a unified TCI state, an uplink (UL) TCI state, or a joint TCI state.

In some embodiments, the reference signal set information may be SSB resource set information, CSI-RS resource set information, or SRS resource set information.

For example, the reference signal set information may include an index of a reference signal set, for example, an index of an SSB resource set, an index of a CSI-RS resource set, or an index of an SRS resource set.

In some embodiments, reference signal information may include SSB resource information, CSI-RS resource information, or SRS resource information. For example, the reference signal information may be an index of an SRS resource, an index of an SSB resource, or an index of a CSI-RS resource.

In some embodiments, the beam information may include an ID or index of a beam.

In embodiments of the disclosure, the beam may also be referred to as a spatial-domain transmission filter (also referred to as “spatial-domain filter for transmission”), a spatial-domain reception filter (also referred to as “spatial-domain filter for reception”), or a spatial Rx parameter.

In some embodiments, the capability set information may include one or more parameters. For example, the capability set information may be a capability set supported by the terminal device or reference signal information associated with the capability set supported by the terminal device.

In some embodiments, the capability set information includes, but is not limited to, at least one of: the maximum number of SRS ports, the maximum number of uplink transmission layers, a codebook subset type, an uplink full-power transmission mode, an SRS antenna-switching capability, an SRS carrier-switching capability, the number of SRS resources for simultaneous transmission, a maximum modulation scheme for uplink data transmission, a maximum modulation scheme for downlink data transmission, the number of hybrid automatic repeat request (HARQ) processes supported by the terminal device, a channel bandwidth supported by the terminal device, the number of transmission antennas supported by the terminal device, a PDSCH processing capability, a PUSCH processing capability, a power-saving capability of the terminal device, a coverage-enhancement capability of the terminal device, a data transmission rate-improvement capability of the terminal device, a short-latency processing capability of the terminal device, a small-data transmission capability of the terminal device, an inactive-data transmission capability of the terminal device, a transmission reliability capability of the terminal device, or an ultra-reliable and low latency communication (URLLC) data transmission capability of the terminal device.

It may be understood that, a first TCI state and a second TCI state involved in the disclosure are merely examples of the at least one spatial parameter, and may not be construed as limiting the disclosure. For example, in other alternative embodiments, the “first TCI state” and the “second TCI state” may also be replaced with other spatial parameters. For example, the “first TCI state” may be replaced with the a “first CORESET group”, and the “second TCI state” may be replaced with a “second CORESET group”.

In some embodiments, the first signaling indicates the first transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

Exemplarily, the candidate transmission schemes include at least one of: FDM scheme A, FDM scheme B, SDM scheme A, SDM scheme B, an SFN scheme, repetition type A, or repetition type B. If the first signaling is RRC signaling, then a structure of the first signaling may be repetitionScheme-r18 ENUMERATED {fdmSchemeA, fdmSchemeB, repetition TypeA, repetition TypeB, sdmSchemeA, sdmSchemeB, sfnScheme}.

In some embodiments, the candidate transmission schemes further include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes further include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In other alternative embodiments, the candidate transmission schemes may also be a combination of other transmission schemes, which will not be limited in embodiments of the disclosure.

Exemplarily, the candidate transmission schemes include at least one of: FDM scheme A, FDM scheme B, SDM scheme A, SDM scheme B, an SFN scheme, repetition type A, repetition type B, an FDM scheme, an SDM scheme, a TDM scheme, or an SFN scheme.

Exemplarily, the candidate transmission schemes include at least one of: FDM scheme A, FDM scheme B, SDM scheme A, SDM scheme B, an SFN scheme, repetition type A, repetition type B, a hybrid scheme of FDM scheme A and repetition type A, or a hybrid scheme of FDM scheme A and repetition type B.

Exemplarily, the candidate transmission schemes include at least one of: FDM scheme A, FDM scheme B, SDM scheme A, SDM scheme B, an SFN scheme, repetition type A, repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

Exemplarily, the candidate transmission schemes include at least one of: an FDM scheme, an SDM scheme, a TDM scheme, an SFN scheme, a hybrid scheme of FDM scheme A and repetition type A, or a hybrid scheme of FDM scheme A and repetition type B.

Exemplarily, the candidate transmission schemes include at least one of: an FDM scheme, an SDM scheme, a TDM scheme, an SFN scheme, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the first signaling is used to configure different transmission schemes.

Exemplarily, different sub-signaling in the first signaling is used to configure different transmission schemes among the candidate transmission schemes.

Exemplarily, the following transmission schemes can be configured through different sub-signaling: FDM scheme A, FDM scheme B, SDM scheme A, SDM scheme B, an SFN scheme, repetition type A, and repetition type B.

Exemplarily, the following transmission schemes can be configured through different sub-signaling: an FDM scheme, an SDM scheme, a TDM scheme, and an SFN scheme.

Exemplarily, the following transmission schemes can be configured through different sub-signaling: FDM scheme A, FDM scheme B, SDM scheme A, SDM scheme B, an SFN scheme, repetition type A, repetition type B, an FDM scheme, an SDM scheme, a TDM scheme, and an SFN scheme.

Exemplarily, the following transmission schemes can be configured through different sub-signaling: FDM scheme A, FDM scheme B, SDM scheme A, SDM scheme B, an SFN scheme, repetition type A, repetition type B, a hybrid scheme of FDM scheme A and repetition type A, and a hybrid scheme of FDM scheme A and repetition type B.

Exemplarily, the following transmission schemes can be configured through different sub-signaling: FDM scheme A, FDM scheme B, SDM scheme A, SDM scheme B, an SFN scheme, repetition type A, repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

Exemplarily, the following transmission schemes can be configured through different sub-signaling: an FDM scheme, an SDM scheme, a TDM scheme, an SFN scheme, a hybrid scheme of FDM scheme A and repetition type A, and a hybrid scheme of FDM scheme A and repetition type B.

Exemplarily, the following transmission schemes can be configured through different sub-signaling: an FDM scheme, an SDM scheme, a TDM scheme, an SFN scheme, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

Exemplarily, when the first signaling is RRC signaling, sub-signaling in the first signaling is also RRC signaling. That is, different transmission schemes can be configured through different RRC signaling. Of course, the first signaling may also be another signaling, which will not be limited in the disclosure.

In some embodiments, the first signaling includes sub-signaling for configuring one of the following transmission schemes: FDM scheme A, FDM scheme B, SDM scheme A, SDM scheme B, and an SFN scheme. Alternatively, the first signaling includes sub-signaling for configuring one of the following transmission schemes: an FDM scheme, an SDM scheme, and an SFN scheme.

Exemplarily, five transmission schemes, namely FDM scheme A, FDM scheme B, SDM scheme A, SDM scheme B, and an SFN scheme, correspond to five different sub-signaling respectively, and the first signaling includes one of the five sub-signaling. Alternatively, three transmission schemes, namely an FDM scheme, an SDM scheme, and an SFN scheme, correspond to three different sub-signaling respectively, and the first signaling includes one of the three sub-signaling.

In some embodiments, the first signaling is not used to simultaneously configure at least two of the following transmission schemes: FDM scheme A, FDM scheme B, SDM scheme A, SDM scheme B, or an SFN scheme. Alternatively, the first signaling is not used to simultaneously configure at least two of the following transmission schemes: an FDM scheme, an SDM scheme, or an SFN scheme.

Exemplarily, the terminal device expects or wishes that the first signaling is not used to simultaneously configure at least two of the following transmission schemes: FDM scheme A, FDM scheme B, SDM scheme A, SDM scheme B, or an SFN scheme. Alternatively, the terminal device expects or wishes that the first signaling is not used to simultaneously configure at least two of the following transmission schemes: an FDM scheme, an SDM scheme, or an SFN scheme.

In other alternative embodiments, the first signaling is not used to simultaneously configure the following transmission schemes: FDM scheme A, FDM scheme B, SDM scheme A, SDM scheme B, an FDM scheme, an SDM scheme, and an SFN scheme.

In some embodiments, operations at S212 may include the following. If the number of the at least one spatial parameter is a first preset number, the second transmission scheme is determined according to the first transmission scheme.

In some embodiments, the operations at S212 may include the following. If the first transmission scheme is an FDM scheme, a transmission scheme indicated by second signaling is determined as the second transmission scheme. Alternatively, if the first transmission scheme is an SDM scheme, a transmission scheme indicated by third signaling is determined as the second transmission scheme. Alternatively, if the first transmission scheme is a TDM scheme, a transmission scheme indicated by fourth signaling is determined as the second transmission scheme. Alternatively, if the first transmission scheme is FDM scheme A, FDM scheme B, SDM scheme A, SDM scheme B, an SFN scheme, repetition type A, or repetition type B, the first transmission scheme is determined as the second transmission scheme. The second signaling indicates FDM scheme A or FDM scheme B, the third signaling indicates SDM scheme A or SDM scheme B, and the fourth signaling indicates repetition type A or repetition type B.

Exemplarily, the second signaling includes, but is not limited to, RRC signaling, an MAC CE, or DCI.

Exemplarily, the second signaling may be the RRC signaling, a signaling structure of which may be implemented as: FDMScheme-r18 ENUMERATED {fdmScheme A, fdmSchemeB}.

Exemplarily, the second signaling may be RV indication information sent by the network device. Only a single RV is used for FDM scheme A, and different RVs are used for FDM scheme B.

That is, if the first transmission scheme is an FDM scheme and an RV(s) indicated by the RV indication information is a single RV, FDM scheme A may be determined as the second transmission scheme. If the first transmission scheme is an FDM scheme and the RV(s) indicated by the RV indication information is multiple RVs, FDM scheme B may be determined as the second transmission scheme.

Exemplarily, the third signaling includes, but is not limited to, RRC signaling, an MAC CE, or DCI.

Exemplarily, the third signaling may be the RRC signaling, a signaling structure of which may be implemented as: SDMscheme-r18 ENUMERATED {sdmSchemeA, sdmSchemeB}. Exemplarily, the third signaling may be RV indication information sent by the network device. Only a single RV is used for SDM scheme A, and different RVs are used for SDM scheme B.

That is, if the first transmission scheme is an SDM scheme and an RV(s) indicated by the RV indication information is a single RV, SDM scheme A may be determined as the second transmission scheme. If the first transmission scheme is an SDM scheme and the RV(s) indicated by the RV indication information is multiple RVs, SDM scheme B may be determined as the second transmission scheme.

Exemplarily, the fourth signaling includes, but is not limited to, RRC signaling, an MAC CE, or DCI.

Exemplarily, the fourth signaling may be the RRC signaling, a signaling structure of which may be implemented as: TDMscheme-r18 ENUMERATED {tdmSchemeA, tdmSchemeB}. In some embodiments, the first preset number is 2.

Exemplarily, the number of the at least one spatial parameter being 2 includes, but is not limited to, any one of the following. The number of TCI states is 2. The number of SRS resource sets is 2. The number of SRS resource sets is 2, and each SRS resource set is associated with one TCI state.

Exemplarily, the at least one spatial parameter may be indicated by the DCI or MAC CE.

Exemplarily, the number of TCI states being 2 means that the number of joint TCI states or UL TCI states indicated by the DCI is 2. For example, the number of joint TCI states or UL TCI states indicated by a TCI field in DCI format 1_1 or 1_2 and DCI format 0_1 or 0_2 is 2.

Exemplarily, the number of TCI states being 2 means that the number of joint TCI states or UL TCI states activated by the MAC CE is 2.

Exemplarily, the number of SRS resource sets being 2 means that a state of a SRS resource set indicator field is ‘10’ or ‘11’. The SRS resource set indicator field may be a field in DCI format 0_1 or 0_2.

In other alternative embodiments, the first preset number may be any integer greater than 1, which will not be limited in embodiments of the disclosure.

In some embodiments, if the number of the at least one spatial parameter is a second preset number, the second transmission scheme is to send the first information in at least one time-domain transmission occasion by using the second preset number of spatial parameters.

In some embodiments, if the first transmission scheme is a TDM scheme, repetition type A, or repetition type B, the second transmission scheme is to repeatedly send the first information in multiple time-domain transmission occasions by using the second preset number of spatial parameters. Alternatively, if the first transmission scheme is an FDM scheme, an SFN scheme, an SDM scheme, FDM scheme A, FDM scheme B, SDM scheme A, or SDM scheme B, the second transmission scheme is to send the first information in one time-domain transmission occasion by using the second preset number of spatial parameters. For example, the second preset number of spatial parameters are pre-defined spatial parameters or default spatial parameters. For example, the second preset number of spatial parameters are spatial parameters with the lowest index, the same spatial parameters as those for a PUSCH scheduled by an RAR UL grant, or spatial parameters quasi co-located with SSBs in an initial-access phase. For example, sending the first information in one time-domain transmission occasion by using the second preset number of spatial parameters may mean that time-domain resources for the first information are time-domain resources indicated by RRC (for example, RRC through which the network device configures time-domain resources for the first information) and/or DCI (for example, a time domain resource allocation (TDRA) field), and frequency-domain resources for the first information are frequency-domain resources indicated by RRC (for example, RRC through which the network device configures frequency-domain resources for the first information) and/or DCI (for example, a frequency domain resource allocation (FDRA) field). In some embodiments, the second preset number is 1.

Exemplarily, the number of the at least one spatial parameter being 1 includes, but is not limited to, any one of the following. The number of TCI states is 1. The number of SRS resource sets is 1. The number of SRS resource sets is 1, and the SRS resource set is associated with one TCI state.

Exemplarily, the at least one spatial parameter may be indicated by the DCI or MAC CE.

Exemplarily, the number of TCI states being 1 means that the number of joint TCI states or UL TCI states indicated by the DCI is 1. For example, the number of joint TCI states or UL TCI states indicated by a TCI field in DCI format 1_1 or 1_2 and DCI format 0_1 or 0_2 is 1.

Exemplarily, the number of TCI states being 1 means that the number of joint TCI states or UL TCI states activated by the MAC CE is 1.

Exemplarily, the number of SRS resource sets being 1 means that a state of a SRS resource set indicator field is ‘00’ or ‘01’. The SRS resource set indicator field may be a field in DCI format 0_1 or 0_2.

In other alternative embodiments, the second preset number may be any integer that is not equal to the first preset number, which will not be limited in embodiments of the disclosure.

In embodiments of the disclosure, by taking the number of the at least one spatial parameter into consideration, the terminal device can determine whether to send or receive the first information based on the multi-TRP based transmission scheme indicated. That is, when the number of the at least one spatial parameter is the second preset number, the terminal device can repeatedly send the first information in multiple time-domain transmission occasions by using the second preset number of spatial parameters, or send the first information in one time-domain transmission occasion by using the second preset number of spatial parameters. As such, the terminal device will not be directly configured with the second transmission scheme through only semi-static signaling or through only dynamic signaling, which is conducive to improving the reliability of data transmission, reducing a data transmission delay, and ensuring the balance of diversity gain, thereby improving system performance.

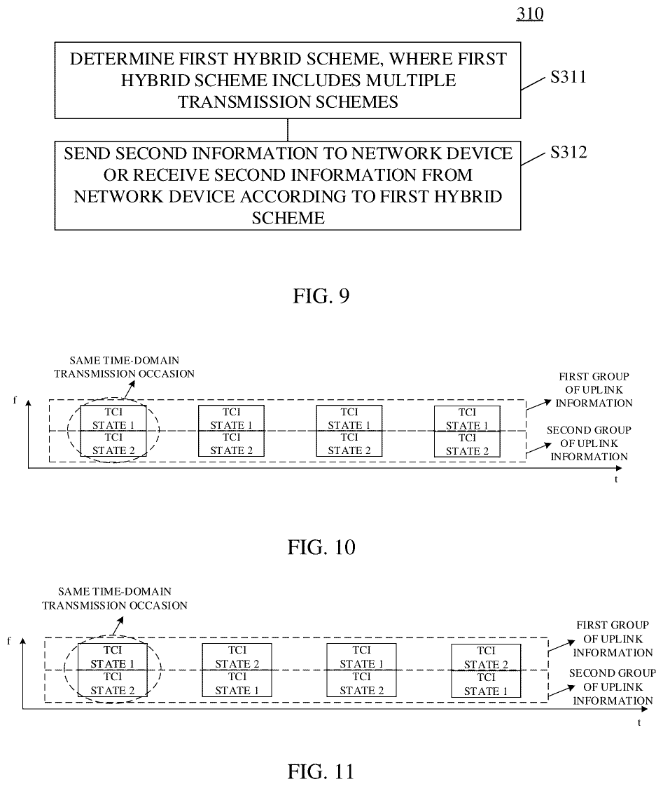

FIG. 9 is a schematic flowchart of a wireless communication method 310 provided in embodiments of the disclosure. The wireless communication method 310 may be performed by a terminal device, for example, the terminal device illustrated in FIG. 1.

As illustrated in FIG. 9, the method 310 may include the following.

At S311, a first hybrid scheme is determined, where the first hybrid scheme includes multiple transmission schemes.

At S312, second information is sent to a network device or received from the network device according to the first hybrid scheme.

A first hybrid scheme is determined, and second information is sent to the network device or received from the network device according to the first hybrid scheme. In this way, the terminal device can send the second information to the network device or receive the second information from the network device according to multiple transmission schemes, which can improve the reliability of data transmission, reduce a data transmission delay, and ensure the balance of diversity gain, thereby improving system performance.

In some embodiments, “the first hybrid scheme includes multiple transmission schemes” may mean that the first hybrid scheme is a combination of the multiple transmission schemes, or may mean that the first hybrid scheme has characteristics of the multiple transmission schemes.

Exemplarily, the second information may be uplink information or downlink information. The “uplink information” may also be equivalent to an “uplink channel”, and the “downlink information” may be equivalent to a “downlink channel”.

Exemplarily, the uplink channel may include a PRACH, a PUCCH, a PUSCH, and the like. An uplink reference signal may include an uplink DMRS, an SRS, a PT-RS, and the like. The uplink DMRS can be used for of uplink channel demodulation, the SRS can be used for uplink channel measurement, uplink time-frequency synchronization, or phase tracking, and the PT-RS can also be used for uplink channel measurement, uplink time-frequency synchronization, or phase tracking.

It may be understood that, an uplink physical channel or uplink reference signal with different functions and the same name as the above may be included in embodiments of the disclosure, and an uplink physical channel or uplink reference signal with different names and the same function as the above may also be included in embodiments of the disclosure, which will not be limited in the disclosure.

In some embodiments, the first hybrid scheme is any one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

Exemplarily, the first hybrid scheme may be a scheme in which at least one of an FDM scheme, an SDM scheme, or an SFN scheme is combined with a TDM scheme.

Exemplarily, the first hybrid scheme may be a scheme in which at least one of FDM scheme A, FDM scheme B, SDM scheme A, SDM scheme B, an SFN scheme, repetition type A, or repetition type B is combined with a TDM scheme.

In some embodiments, operations at S311 may include the following. Fifth signaling is received from the network device. A transmission scheme configured by the fifth signaling is determined as the first hybrid scheme, or the first hybrid scheme is determined according to the transmission scheme configured by the fifth signaling.

Exemplarily, the fifth signaling may be semi-static signaling, and the semi-static signaling includes, but is not limited to, RRC signaling and MAC-CE signaling.

In some embodiments, the operations at S311 may include the following. If the transmission scheme configured by the fifth signaling is a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B, then the transmission scheme configured by the fifth signaling is determined as the first hybrid scheme. If the transmission scheme configured by the fifth signaling is an FDM scheme or the transmission scheme configured by the fifth signaling is a hybrid scheme of an FDM scheme and a TDM scheme, then a hybrid scheme of a transmission scheme indicated by second signaling and a transmission scheme indicated by fourth signaling is determined as the first hybrid scheme. Alternatively, if the transmission scheme configured by the fifth signaling is an SDM scheme or the transmission scheme configured by the fifth signaling is a hybrid scheme of an SDM scheme and a TDM scheme, then a hybrid scheme of a transmission scheme indicated by third signaling and the transmission scheme indicated by the fourth signaling is determined as the first hybrid scheme. Alternatively, if the transmission scheme configured by the fifth signaling is FDM scheme A, FDM scheme B, SDM scheme A, SDM scheme B, or an SFN scheme, then a hybrid scheme of the transmission scheme configured by the fifth signaling and the transmission scheme indicated by the fourth signaling is determined as the first hybrid scheme. The second signaling indicates FDM scheme A or FDM scheme B, the third signaling indicates SDM scheme A or SDM scheme B, and the fourth signaling indicates repetition type A or repetition type B.

Exemplarily, the second signaling includes, but is not limited to, RRC signaling, an MAC CE, or DCI.

Exemplarily, the second signaling may be the RRC signaling, a signaling structure of which may be implemented as: FDMScheme-r18 ENUMERATED {fdmSchemeA, fdmSchemeB}.

Exemplarily, the second signaling may be RV indication information sent by the network device. Only a single RV is used for FDM scheme A, and different RVs are used for FDM scheme B.

That is, if the first transmission scheme is an FDM scheme and an RV(s) indicated by the RV indication information is a single RV, FDM scheme A may be determined as the transmission scheme indicated by the second signaling. If the first transmission scheme is an FDM scheme and the RV(s) indicated by the RV indication information is multiple RVs, FDM scheme B may be determined as the transmission scheme indicated by the second signaling. Exemplarily, the third signaling includes, but is not limited to, RRC signaling, an

MAC CE, or DCI.

Exemplarily, the third signaling may be the RRC signaling, a signaling structure of which may be implemented as: SDMscheme-r18 ENUMERATED {sdmSchemeA, sdmSchemeB}.

Exemplarily, the third signaling may be RV indication information sent by the network device. Only a single RV is used for SDM scheme A, and different RVs are used for SDM scheme B.

That is, if the first transmission scheme is an SDM scheme and an RV(s) indicated by the RV indication information is a single RV, SDM scheme A may be determined as the transmission scheme indicated by the third signaling. If the first transmission scheme is an SDM scheme and the RV(s) indicated by the RV indication information is multiple RVs, SDM scheme B may be determined as the transmission scheme indicated by the third signaling.

Exemplarily, the fourth signaling includes, but is not limited to, RRC signaling, an MAC CE, or DCI.

Exemplarily, the fourth signaling may be the RRC signaling, a signaling structure of which may be implemented as: TDMscheme-r18 ENUMERATED {tdmSchemeA, tdmSchemeB}.

In some embodiments, the fifth signaling is used to configure a transmission scheme among candidate transmission schemes.

In some embodiments, the candidate transmission schemes include at least one of:

FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

Exemplarily, the candidate transmission schemes include at least one of: FDM scheme A, FDM scheme B, SDM scheme A, SDM scheme B, an SFN scheme, repetition type A, or repetition type B. If the first signaling is RRC signaling, then a structure of the first signaling may be repetitionScheme-r18 ENUMERATED {fdmSchemeA, fdmSchemeB, repetition TypeA, repetition TypeB, sdmSchemeA, sdmSchemeB, sfnScheme}.

In some embodiments, the candidate transmission schemes include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In other alternative embodiments, the candidate transmission schemes may also be a combination of other transmission schemes, which will not be limited in embodiments of the disclosure.

Exemplarily, the candidate transmission schemes include at least one of: FDM scheme A, FDM scheme B, SDM scheme A, SDM scheme B, an SFN scheme, repetition type A, repetition type B, an FDM scheme, an SDM scheme, a TDM scheme, or an SFN scheme.

Exemplarily, the candidate transmission schemes include at least one of: a hybrid scheme of an FDM scheme and a TDM scheme, a hybrid scheme of an SDM scheme and a TDM scheme, a hybrid scheme of an SFN scheme and a TDM scheme, a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

Exemplarily, the candidate transmission schemes include at least one of: FDM scheme A, FDM scheme B, SDM scheme A, SDM scheme B, an SFN scheme, repetition type A, repetition type B, a hybrid scheme of FDM scheme A and repetition type A, or a hybrid scheme of FDM scheme A and repetition type B.

Exemplarily, the candidate transmission schemes include at least one of: FDM scheme A, FDM scheme B, SDM scheme A, SDM scheme B, an SFN scheme, repetition type A, repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

Exemplarily, the candidate transmission schemes include at least one of: an FDM scheme, an SDM scheme, a TDM scheme, an SFN scheme, a hybrid scheme of FDM scheme A and repetition type A, or a hybrid scheme of FDM scheme A and repetition type B.

Exemplarily, the candidate transmission schemes include at least one of: an FDM scheme, an SDM scheme, a TDM scheme, an SFN scheme, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the fifth signaling is used to configure different transmission schemes.

Exemplarily, different sub-signaling in the fifth signaling is used to configure different transmission schemes among the candidate transmission schemes.

Exemplarily, the following transmission schemes can be configured through different sub-signaling: FDM scheme A, FDM scheme B, SDM scheme A, SDM scheme B, an SFN scheme, repetition type A, and repetition type B.

Exemplarily, the following transmission schemes can be configured through different sub-signaling: an FDM scheme, an SDM scheme, a TDM scheme, and an SFN scheme.

Exemplarily, the following transmission schemes can be configured through different sub-signaling: FDM scheme A, FDM scheme B, SDM scheme A, SDM scheme B, an SFN scheme, repetition type A, repetition type B, an FDM scheme, an SDM scheme, a TDM scheme, and an SFN scheme.

Exemplarily, the following transmission schemes can be configured through different sub-signaling: a hybrid scheme of an FDM scheme and a TDM scheme, a hybrid scheme of an SDM scheme and a TDM scheme, and a hybrid scheme of an SFN scheme and a TDM scheme.

Exemplarily, the following transmission schemes can be configured through different sub-signaling: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

Exemplarily, the following transmission schemes can be configured through different sub-signaling: a hybrid scheme of an FDM scheme and a TDM scheme, a hybrid scheme of an SDM scheme and a TDM scheme, a hybrid scheme of an SFN scheme and a TDM scheme, a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

Exemplarily, the following transmission schemes can be configured through different sub-signaling: FDM scheme A, FDM scheme B, SDM scheme A, SDM scheme B, an SFN scheme, repetition type A, repetition type B, a hybrid scheme of FDM scheme A and repetition type A, and a hybrid scheme of FDM scheme A and repetition type B.

Exemplarily, the following transmission schemes can be configured through different sub-signaling: FDM scheme A, FDM scheme B, SDM scheme A, SDM scheme B, an SFN scheme, repetition type A, repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

Exemplarily, the following transmission schemes can be configured through different sub-signaling: an FDM scheme, an SDM scheme, a TDM scheme, an SFN scheme, a hybrid scheme of FDM scheme A and repetition type A, and a hybrid scheme of FDM scheme A and repetition type B.

Exemplarily, the following transmission schemes can be configured through different sub-signaling: an FDM scheme, an SDM scheme, a TDM scheme, an SFN scheme, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

Exemplarily, when the first signaling is RRC signaling, sub-signaling in the first signaling is also RRC signaling. That is, different transmission schemes can be configured through different RRC signaling. Of course, the first signaling may also be another signaling, which will not be limited in the disclosure.

In some embodiments, the fifth signaling includes sub-signaling for configuring one of the following transmission schemes: FDM scheme A, FDM scheme B, SDM scheme A, SDM scheme B, and an SFN scheme. Alternatively, the fifth signaling includes sub-signaling for configuring one of the following transmission schemes: an FDM scheme, an SDM scheme, and an SFN scheme.

Exemplarily, five transmission schemes, namely FDM scheme A, FDM scheme B, SDM scheme A, SDM scheme B, and an SFN scheme, correspond to five different sub-signaling respectively, and the fifth signaling includes one of the five sub-signaling. Alternatively, three transmission schemes, namely an FDM scheme, an SDM scheme, and an SFN scheme, correspond to three different sub-signaling respectively, and the fifth signaling includes one of the three sub-signaling.

In some embodiments, the fifth signaling is not used to simultaneously configure at least two of: FDM scheme A, FDM scheme B, SDM scheme A, SDM scheme B, or an SFN scheme. Alternatively, the fifth signaling is not used to simultaneously configure two of the following schemes: an FDM scheme, an SDM scheme, or an SFN scheme.

Exemplarily, the terminal device expects or wishes that the fifth signaling is not used to simultaneously configure at least two of the following transmission schemes: FDM scheme A, FDM scheme B, SDM scheme A, SDM scheme B, or an SFN scheme. Alternatively, the terminal device expects or wishes that the fifth signaling is not used to simultaneously configure at least two of the following transmission schemes: an FDM scheme, an SDM scheme, or an SFN scheme.

In other alternative embodiments, the fifth signaling is not used to simultaneously configure at least two of: FDM scheme A, FDM scheme B, SDM scheme A, SDM scheme B, an FDM scheme, an SDM scheme, or an SFN scheme.

In some embodiments, operations at S312 may include the following. If the number of at least one spatial parameter associated with the second information is a first preset number, the second information is sent to the network device or received from the network device according to the first hybrid scheme.

Exemplarily, the spatial parameter includes at least one of: TCI state information, antenna panel information, TRP information, CORESET group information, reference signal set information, capability set information, beam information, or the like. An antenna panel is a logical entity used by the terminal device for transmission, and transmission beams and/or reception beams for antennas on different antenna panels can be independently adjusted.

In some embodiments, the antenna panel information may include an ID or index of an antenna panel.

In some embodiments, the TRP information may include an ID or index of a TRP.

In some embodiments, the CORESET group information may include an ID or index of a CORESET group.

In some embodiments, the TCI state information may include a unified TCI state, an UL TCI state, or a joint TCI state.

In some embodiments, the reference signal set information may be SSB resource set information, CSI-RS resource set information, or SRS resource set information.

For example, the reference signal set information may include an index of a reference signal set, for example, an index of an SSB set, an index of a CSI-RS resource, or an index of an SRS resource.

In some embodiments, reference signal information may include SSB resource information, CSI-RS resource information, or SRS resource information. For example, the reference signal information may be an index of an SRS resource, an index of an SSB resource, or an index of a CSI-RS resource.

In some embodiments, the beam information may include an ID or index of a beam.

In embodiments of the disclosure, the beam may also be referred to as a spatial-domain transmission filter (also referred to as “spatial-domain filter for transmission”), a spatial-domain reception filter (also referred to as “spatial-domain filter for reception”), or a spatial Rx parameter.

In some embodiments, the capability set information may include one or more parameters. For example, the capability set information may be a capability set supported by the terminal device or reference signal information associated with the capability set supported by the terminal device.

In some embodiments, the capability set information includes, but is not limited to, at least one of: the maximum number of SRS ports, the maximum number of uplink transmission layers, a codebook subset type, an uplink full-power transmission mode, an SRS antenna-switching capability, an SRS carrier-switching capability, the number of SRS resources for simultaneous transmission, a maximum modulation scheme for uplink data transmission, a maximum modulation scheme for downlink data transmission, the number of HARQ processes supported by the terminal device, a channel bandwidth supported by the terminal device, the number of transmission antennas supported by the terminal device, a PDSCH processing capability, a PUSCH processing capability, a power-saving capability of the terminal device, a coverage-enhancement capability of the terminal device, a data transmission rate-improvement capability of the terminal device, a short-latency processing capability of the terminal device, a small-data transmission capability of the terminal device, an inactive-data transmission capability of the terminal device, a transmission reliability capability of the terminal device, or a URLLC data transmission capability of the terminal device.

It may be understood that, a first TCI state and a second TCI state involved in the disclosure are merely examples of the at least one spatial parameter, and may not be construed as limiting the disclosure. For example, in other alternative embodiments, the “first TCI state” and the “second TCI state” may also be replaced with other spatial parameters. For example, the “first TCI state” may be replaced with the a “first CORESET group”, and the “second TCI state” may be replaced with a “second CORESET group”.

In some embodiments, the first preset number is 2.

Exemplarily, the number of the at least one spatial parameter being 2 includes, but is not limited to, any one of the following. The number of TCI states is 2. The number of SRS resource sets is 2. The number of SRS resource sets is 2, and each SRS resource set is associated with one TCI state.

Exemplarily, the at least one spatial parameter may be indicated by the DCI or MAC CE.

Exemplarily, the number of TCI states being 2 means that the number of joint TCI states or UL TCI states indicated by the DCI is 2. For example, the number of joint TCI states or UL TCI states indicated by a TCI field in DCI format 1_1 or 1_2 and DCI format 0_1 or 0_2 is 2.

Exemplarily, the number of TCI states being 2 means that the number of joint TCI states or UL TCI states activated by the MAC CE is 2.

Exemplarily, the number of SRS resource sets being 2 means that a state of a SRS resource set indicator field is ‘10’ or ‘11’. The SRS resource set indicator field may be a field in DCI format 0_1 or 0_2.

In other alternative embodiments, the first preset number may be any integer greater than 1, which will not be limited in embodiments of the disclosure.

In some embodiments, the method 310 may further include the following. If the number of the at least one spatial parameter is a second preset number, the second information is sent repeatedly to the network device or the second information is received repeatedly from the network device in multiple time-domain transmission occasions by using the second preset number of spatial parameters. For example, the second preset number of spatial parameters are pre-defined spatial parameters or default spatial parameters. For example, the second preset number of spatial parameters are spatial parameters with the lowest index, the same spatial parameters as those for a PUSCH scheduled by an RAR UL grant, or spatial parameters quasi co-located with SSBs in an initial-access phase. For example, “repeatedly sending the second information to the network device or repeatedly receiving the second information from the network device in multiple time-domain transmission occasions by using the second preset number of spatial parameters” may mean that time-domain resources for the second information are multiple time-domain resources indicated by RRC (for example, RRC through which the network device configures time-domain resources for the second information) and/or an MAC CE (for example, an MAC CE through which the network device configures time-domain resources for the second information) and/or DCI (for example, a TDRA field), and frequency-domain resources for the second information are frequency-domain resources indicated by RRC (for example, RRC through which the network device configures frequency-domain resources for the second information) and/or an MAC CE (for example, an MAC CE through which the network device configures frequency-domain resources for the second information) and/or DCI (for example, an FDRA field).

In some embodiments, the second preset number is 1.

Exemplarily, the number of the at least one spatial parameter being 1 includes, but is not limited to, any one of the following. The number of TCI states is 1. The number of SRS resource sets is 1. The number of SRS resource sets is 1, and the SRS resource set is associated with one TCI state.

Exemplarily, the at least one spatial parameter may be indicated by the DCI or MAC CE.

Exemplarily, the number of TCI states being 1 means that the number of joint TCI states or UL TCI states indicated by the DCI is 1. For example, the number of joint TCI states or UL TCI states indicated by a TCI field in DCI format 1_1 or 1_2 and DCI format 0_1 or 0_2 is 1.

Exemplarily, the number of TCI states being 1 means that the number of joint TCI states or UL TCI states activated by the MAC CE is 1.

Exemplarily, the number of SRS resource sets being 1 means that a state of a SRS resource set indicator field is ‘00’ or ‘01’. The SRS resource set indicator field may be a field in DCI format 0_1 or 0_2.

In other alternative embodiments, the second preset number may be any integer that is not equal to the first preset number, which will not be limited in embodiments of the disclosure.

In some embodiments, the second information includes a first group of uplink information and a second group of uplink information. A mapping manner of the first hybrid scheme for a TCI state includes the following. The first group of uplink information and the second group of uplink information are sent in a same time-domain transmission occasion in an FDM or SDM or SFN manner. A same group of uplink information is sent in different time-domain transmission occasions in a TDM manner.

In other words, the second information may be divided into two groups of uplink information in a dimension of a frequency domain, a spatial domain, or a DMRS port. As such, the terminal device can send each group of uplink information to the network device in a time domain in a TDM manner.

Exemplarily, the time-domain transmission occasion may be a transmission occasion indicated by the DCI.

In some embodiments, the first group of uplink information is associated with the first TCI state, and the second group of uplink information is associated with the second TCI state.

Exemplarily, the first uplink information associated with the first TCI state is the first uplink information in the first group of uplink information, and the first uplink information associated with the second TCI state is the first uplink information in the second group of uplink information.

FIG. 10 illustrates an example of a mapping manner of a first hybrid scheme for a TCI state provided in embodiments of the disclosure.

As illustrated in FIG. 10, for the first group of uplink information and the second group of uplink information, the two groups of uplink information sent in the same time-domain transmission occasion in the FDM or SDM or SFN manner are associated with different TCI states, and the same group of uplink information sent in different time-domain transmission occasions in the TDM manner is associated with the same TCI state. That is, the first group of uplink information includes four uplink information associated with TCI state 1, and the second group of uplink information includes four uplink information associated with TCI state 2.

In some embodiments, at least one uplink information associated with a second TCI state in the first group of uplink information exists between two adjacent uplink information associated with a first TCI state in the first group of uplink information. At least one uplink information associated with the second TCI state in the second group of uplink information exists between two adjacent uplink information associated with the first TCI state in the second group of uplink information.

Exemplarily, the first uplink information associated with the first TCI state is the first uplink information in the first group of uplink information, and the first uplink information associated with the second TCI state is the first uplink information in the second group of uplink information.

Exemplarily, the number of the at least one uplink information is 1 or another value.

Exemplarily, the number of the at least one uplink information is determined according to the number of the at least one spatial parameter associated with the first information. For example, the number of the at least one uplink information is the number of the at least one spatial parameter associated with the first information minus 1.

FIG. 11 illustrates an example of a mapping manner of a first hybrid scheme for a TCI state provided in embodiments of the disclosure.

As illustrated in FIG. 11, for the first group of uplink information and the second group of uplink information, the two groups of uplink information sent in the same time-domain transmission occasion in the FDM or SDM or SFN manner are associated with the first TCI state and the second TCI state respectively, and different groups of uplink information sent in the same time-domain transmission occasion in the TDM manner are associated with different TCI states. That is, the first group of uplink information includes four uplink information that is sequentially associated with TCI state 1, TCI state 2, TCI state 1, and TCI state 2, and the second group of uplink information includes four uplink information that is sequentially associated with TCI state 2, TCI state 1, TCI state 2, and TCI state 1.

It may be understood that in other alternative embodiments of the disclosure, a mapping manner of the first hybrid scheme for another spatial parameter is similar to the mapping manner of the first hybrid scheme for the TCI state. Taking a mapping manner of the first hybrid scheme for an SRS resource set as an example, regarding the mapping manner of the first hybrid scheme for the TCI state, the “first TCI state” can be replaced with a “first SRS resource set”, and the “second TCI state” can be replaced with a “second SRS resource set”, which will not be repeated herein.

In some embodiments, a mapping manner of the first hybrid scheme for an RV includes the following. A preset number of RVs are cyclically used for uplink information sent in different time-domain transmission occasions. A same RV is used for uplink information associated with different TCI states that is sent in a same time-domain transmission occasion.

Exemplarily, if the number of time-domain transmission occasions for the second information is less than or equal to the preset number of RVs, different RVs are used for uplink information sent in different time-domain transmission occasions, and the same RV is used for uplink information associated with different TCI states that is sent in the same time-domain transmission occasion.

Exemplarily, if the number of time-domain transmission occasions for the second information is greater than the preset number of RVs, the preset number of RVs are cyclically used for uplink information sent in different time-domain transmission occasions, and the same RV is used for uplink information associated with different TCI states that is sent in the same time-domain transmission occasion.

Exemplarily, cyclical use of the preset number of RVs means that the RVs are sequentially and cyclically used. For example, assuming that the time-domain transmission occasions for the second information include six time-domain transmission occasions and the preset number is 4 (the RVs are RV 0, RV 1, RV 2, and RV 3 respectively), the round-robin order is sequentially RV 0, RV 1, RV 2, and RV 3. If an ID of an RV used in the first one of the six time-domain transmission occasions is 1, then IDs of RVs used in N time-domain transmission occasions are sequentially RV 1, RV 2, RV 3, RV 0, RV 1, and RV 2. That is, after RV 3 is used, restart from RV 0. For example, assuming that the time-domain transmission occasions for the second information include six time-domain transmission occasions (i.e., 6 repetitions of the second information in the time domain) and the preset number is 4 (the RVs are RV 0, RV 1, RV 2, and RV 3 respectively), the round-robin order is sequentially RV 0, RV 2, RV 3, and RV 1. If an ID of an RV used in the first one of the six time-domain transmission occasions is 0, then IDs of RVs used in N time-domain transmission occasions are sequentially RV 0, RV 2, RV 3, RV1, RV 0, and RV 2. That is, after RV 1 is used, restart from RV 0.

In some embodiments, the second information includes a first group of uplink information and a second group of uplink information. A mapping manner of the first hybrid scheme for an RV includes the following. A same RV pattern is used for the first group of uplink information and the second group of uplink information.

In some embodiments, an RV pattern is an RV corresponding to the second information sent in the n-th transmission occasion.

In some embodiments, the RV pattern is a RV sequence formed by the preset number of RVs in a specific order. For example, the preset number is 4.

In some embodiments, “the same RV pattern is used for the first group of uplink information and the second group of uplink information” may mean that in the first group of uplink information and the second group of uplink information, second information sent in the same time-domain transmission occasion corresponds to the same RV.

In some embodiments, both a first RV used for the first uplink information in the first group of uplink information and a second RV used for the first uplink information in the second group of uplink information are RVs indicated by DCI, and the first RV is the same as the second RV.

Exemplarily, the first uplink information in the first group of uplink information is uplink information that is first sent in the time domain in the first group of uplink information.

Exemplarily, the first uplink information in the second group of uplink information is uplink information that is first sent in the time domain in the second group of uplink information.

Exemplarily, if the first group of uplink information and the second group of uplink information belong to different codewords, both the first RV and the second RV are the RVs indicated by the DCI.

Exemplarily, if single-codeword transmission is not used for the first group of uplink information and the second group of uplink information, both the first RV and the second RV are the RVs indicated by the DCI. In other words, if multi-codeword transmission is used for the first group of uplink information and the second group of uplink information, both the first RV and the second RV are the RVs indicated by the DCI. For the single-codeword transmission, one modulation and coding scheme (MCS) is used for the first group of uplink information and the second group of uplink information. For the multi-codeword transmission, multiple MCSs are used for the first group of uplink information and the second group of uplink information.

In some embodiments, both an ID of an RV used for n-th uplink information in the first group of uplink information and an ID of an RV used for n-th uplink information in the second group of uplink information are determined according to n and a first RV used for the first uplink information in the first group of uplink information.

Exemplarily, both the ID of the RV used for the n-th uplink information in the first group of uplink information and the ID of the RV used for the n-th uplink information in the second group of uplink information are IDs corresponding to i and (n mod 4), where i is an ID of the first RV.

The ID of the RV used for the n-th uplink information will be described below with reference to Table 1.

TABLE 1

| RV ID | | | | |
|---|---|---|---|---|
| indicated | ID of RV used for n-th uplink information | | | |
| by DCI | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

As illustrated in Table 1, assuming that the preset number of RVs is 4 and the RV ID (i.e., the ID of the first RV) indicated by the DCI is 0, an ID of an RV used for the first uplink information is RV 0, an ID of an RV used for the second uplink information is an RV corresponding to 0 and (2 mod 4), i.e., RV 3, an ID of an RV used for the third uplink information is an RV corresponding to 0 and (3 mod 4) RV, i.e., RV 1, an ID of an RV used for the fourth uplink information is an RV corresponding to 0 and (4 mod 4), i.e., RV 0, and so on, until an ID of an RV used for each uplink information in the first group of uplink information and the second group of uplink information is determined.

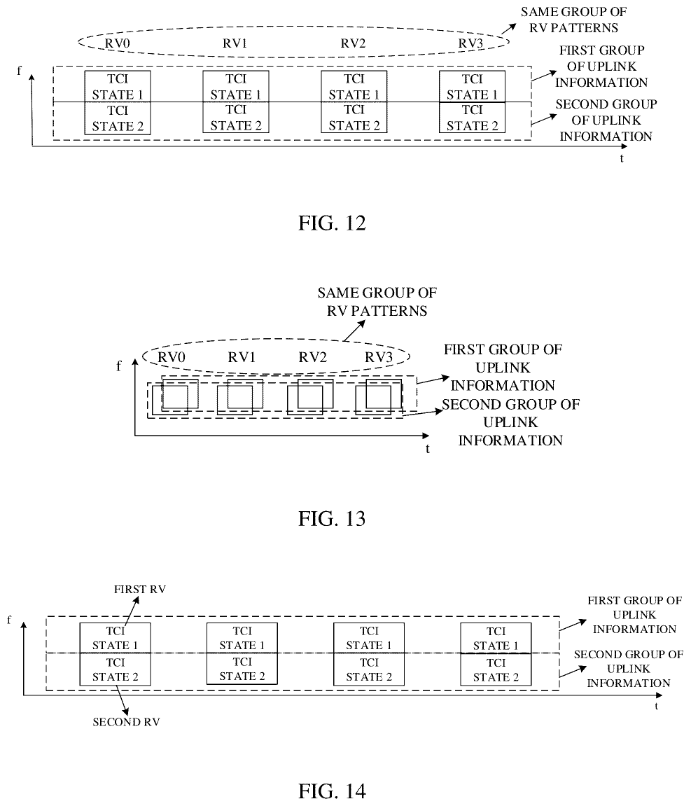

FIG. 12 illustrates an example of a mapping manner of a first hybrid scheme for an RV provided in embodiments of the disclosure.

As illustrated in FIG. 12, taking the mapping manner of the first hybrid scheme for the TCI state illustrated in FIG. 10 as an example, for a hybrid scheme of FDM scheme A and repetition type A or a hybrid scheme of FDM scheme A and repetition type B, the mapping manner of the first hybrid scheme for the RV may include the following. The same RV pattern is used for the first group of uplink information and the second group of uplink information. For example, the same RV 0, RV 1, RV 2, and RV 3 are sequentially used for four uplink information associated with TCI state 1 (i.e., the first group of uplink information) and four uplink information associated with TCI state 2 (i.e., the second group of uplink information). FIG. 13 illustrates another example of a mapping manner of a first hybrid scheme for an RV provided in embodiments of the disclosure.

As illustrated in FIG. 13, for a hybrid scheme of SDM scheme A and repetition type A, a hybrid scheme of SDM scheme A and repetition type B, a hybrid scheme of an SFN scheme and repetition type A, or a hybrid scheme of an SFN scheme and repetition type B, the mapping manner of the first hybrid scheme for the RV may include the following. The same RV pattern is used for the first group of uplink information and the second group of uplink information. For example, the same RV 0, RV 1, RV 2, and RV 3 are sequentially used for four uplink information associated with TCI state 1 (i.e., the first group of uplink information) and four uplink information associated with TCI state 2 (i.e., the second group of uplink information).

It may be understood that, FIG. 12 and FIG. 13 merely illustrate examples of the disclosure and may not be construed as limiting the disclosure.

For example, in other alternative embodiments, in addition to a hybrid scheme of FDM scheme A and repetition type A or a hybrid scheme of FDM scheme A and repetition type B, a hybrid scheme of SDM scheme A and repetition type A, a hybrid scheme of SDM scheme A and repetition type B, a hybrid scheme of an SFN scheme and repetition type A, and a hybrid scheme of an SFN scheme and repetition type B, the mapping manner of the first hybrid scheme for the RV provided in FIG. 12 or FIG. 13 may also be applied to other schemes.

In some embodiments, the mapping manner of the first hybrid scheme for the RV includes the following. A preset number of RVs are cyclically used for uplink information sent in different time-domain transmission occasions. Different RVs are used for uplink information associated with different TCI states that is sent in a same time-domain transmission occasion.

Exemplarily, if the number of time-domain transmission occasions for the second information is less than or equal to the preset number of RVs, different RVs are used for uplink information sent in different time-domain transmission occasions, and different RVs are used for uplink information associated with different TCI states that is sent in the same time-domain transmission occasion.

Exemplarily, if the number of time-domain transmission occasions for the second information is greater than the preset number of RVs, the preset number of RVs are cyclically used for uplink information sent in different time-domain transmission occasions, and different RVs are used for uplink information associated with different TCI states that is sent in the same time-domain transmission occasion.

In some embodiments, different time-domain transmission occasions may refer to different transmission occasions for time-domain resources. The same time-domain transmission occasion may refer to the same transmission occasion for the time-domain resources.

Exemplarily, cyclical use of the preset number of RVs means that the RVs are sequentially mapped in a round-robin order. For example, assuming that the time-domain transmission occasions for the second information include six time-domain transmission occasions and the preset number is 4 (the RVs are RV 0, RV 1, RV 2, and RV 3 respectively), the round-robin order is sequentially RV 0, RV 1, RV 2, and RV 3. If an ID of an RV used in the first one of the six time-domain transmission occasions is 1, then IDs of RVs used in N time-domain transmission occasions are sequentially RV 1, RV 2, RV 3, RV 0, RV 1, and RV 2. That is, after RV 3 is used, restart from RV 0. For example, assuming that the time-domain transmission occasions for the second information include six time-domain transmission occasions (i.e., 6 repetitions of the second information in the time domain) and the preset number is 4 (the RVs are RV 0, RV 1, RV 2, and RV 3 respectively), the round-robin order is sequentially RV 0, RV 2, RV 3, and RV 1. If an ID of an RV used in the first one of the six time-domain transmission occasions is 0, then IDs of RVs used in N time-domain transmission occasions are sequentially RV 0, RV 2, RV 3, RV1, RV 0, and RV 2. That is, after RV 1 is used, restart from RV 0.

In some embodiments, the second information includes a first group of uplink information and a second group of uplink information. A mapping manner of the first hybrid scheme for an RV includes the following. Different RV patterns are used for the first group of uplink information and the second group of uplink information.

In some embodiments, an RV pattern is an RV corresponding to the second information sent in the n-th transmission occasion.

In some embodiments, the RV pattern is a RV sequence formed by the preset number of RVs in a specific order. For example, the preset number is 4.

In some embodiments, “different RV patterns are used for the first group of uplink information and the second group of uplink information” may mean that in the first group of uplink information and the second group of uplink information, second information sent in the same time-domain transmission occasion corresponds to different RVs.

In some embodiments, a first group of RV patterns are used for the first group of uplink information, a second group of RV patterns are used for the second group of uplink information, and the second group of RV patterns have an RV offset relative to the first group of RV patterns.

Exemplarily, a first RV in the second group of RV patterns has an RV offset relative to

a first RV in the first group of RV patterns.

In some embodiments, a first RV used for the first uplink information in the first group of uplink information is an RV indicated by DCI, and a second RV used for the first uplink information in the second group of uplink information is an RV offset from the first RV.

Exemplarily, the first uplink information in the first group of uplink information is uplink information that is first sent in the time domain in the first group of uplink information.

Exemplarily, the first uplink information in the second group of uplink information is uplink information that is first sent in the time domain in the second group of uplink information.

Exemplarily, an ID of the second RV is the sum of an ID of the first RV and RVoffset. RVoffset is an offset of the ID of the second RV shifted backward relative to an ID of the first RV, or RVoffset is an offset of the ID of the first RV shifted forward relative to the ID of the second RV.

In some embodiments, an ID of an RV used for n-th uplink information in the first group of uplink information is determined according to an ID of the first RV and n. An ID of an RV used for n-th uplink information in the second group of uplink information is determined according to the ID of the first RV, an offset of the second RV relative to the first RV, and n.

Exemplarily, the ID of the RV used for the n-th uplink information in the first group of uplink information is an ID corresponding to i and (n mod 4), where i is the ID of the first RV. For example, the ID of the RV used for the n-th uplink information in the first group of uplink information may be determined according to Table 1, which will not be repeated herein.

Exemplarily, a calculation method for the ID of the RV used for the n-th uplink information in the second group of uplink information is a calculation method corresponding to i and (n mod 4), where i is the ID of the first RV.

The ID of the RV used for the n-th uplink information in the second group of uplink information will be described below with reference to Table 2.

TABLE 2

| RV ID | | | | |
|---|---|---|---|---|
| indicated | RV for n-th uplink information (uplink information associated with another TCI state) | | | |
| by DCI | n mod 4 = 0 | n mod 4 = 1 | n mod 4 = 2 | n mod 4 = 3 |
| 0 | (0 + RVoffset)mod 4 | (2 + RVoffset)mod 4 | (3 + RVoffset)mod 4 | (1 + RVoffset)mod 4 |
| 2 | (2 + RVoffset)mod 4 | (3 + RVoffset)mod 4 | (1 + RVoffset)mod 4 | (0 + RVoffset)mod 4 |
| 3 | (3 + RVoffset)mod 4 | (1 + RVoffset)mod 4 | (0 + RVoffset)mod 4 | (2 + RVoffset)mod 4 |
| 1 | (1 + RVoffset)mod 4 | (0 + RVoffset)mod 4 | (2 + RVoffset)mod 4 | (3 + RVoffset)mod 4 |

As illustrated in Table 2, assuming that the preset number of RVs is 4 and the ID of the first RV is 0, an ID of an RV used for the first uplink information in the second group of uplink information is calculated in a calculation method corresponding to 0 and (1 mod 4), i.e., is an RV calculated according to (2+RVoffset) mod 4. Similarly, an ID of an RV used for the second uplink information is calculated in a calculation method corresponding to 0 and (2 mod 4), i.e., is an RV calculated according to (3+RVoffset) mod 4. An ID of an RV used for the third uplink information is calculated in a calculation method corresponding to 0 and (3 mod 4), i.e., is an RV calculated according to (1+RVoffset) mod 4. An ID of an RV used for the fourth uplink information is calculated in a calculation method corresponding to 0 and (4 mod 4), i.e., is an RV calculated according to (0+RVoffset) mod 4, and so on, until an ID of an RV used for each uplink information in the second group of uplink information is determined.

In some embodiments, if the first group of uplink information and the second group of uplink information belong to a same codeword, the second RV is the RV offset from the first RV.

In some embodiments, both a first RV used for the first uplink information in the first group of uplink information and a second RV used for the first uplink information in the second group of uplink information are RVs indicated by DCI; and the first RV is different from the second RV.

Exemplarily, the first uplink information in the first group of uplink information is uplink information that is first sent in the time domain in the first group of uplink information. Exemplarily, the first uplink information in the second group of uplink information is

uplink information that is first sent in the time domain in the second group of uplink information.

In some embodiments, an ID of an RV used for n-th uplink information in the first group of uplink information is determined according to the first RV and n, and an ID of an RV used for n-th uplink information in the second group of uplink information is determined according to the second RV and n.

Exemplarily, if the first group of uplink information and the second group of uplink information belong to different codewords, both the first RV and the second RV are the RVs indicated by the DCI.

Exemplarily, if single-codeword transmission is not used for the first group of uplink information and the second group of uplink information, both the first RV and the second RV are the RVs indicated by the DCI. In other words, if multi-codeword transmission is used for the first group of uplink information and the second group of uplink information, both the first RV and the second RV are the RVs indicated by the DCI. For the single-codeword transmission, one MCS is used for the first group of uplink information and the second group of uplink information. For the multi-codeword transmission, multiple MCSs are used for the first group of uplink information and the second group of uplink information.

FIG. 14 illustrates an example of a mapping manner of a first hybrid scheme for an RV provided in embodiments of the disclosure.

As illustrated in FIG. 14, taking the mapping manner of the first hybrid scheme for the TCI state illustrated in FIG. 10 as an example, for a hybrid scheme of FDM scheme B and repetition type A or a hybrid scheme of FDM scheme B and repetition type B, the mapping manner of the first hybrid scheme for the RV may include the following. Different RV patterns are used for the first group of uplink information and the second group of uplink information. That is, the first RV is used for the first one of four uplink information associated with TCI state 1 (i.e., the first group of uplink information), and the second RV is used for the first one of four uplink information associated with TCI state 2 (i.e., the second group of uplink information). The first RV is different from the second RV.

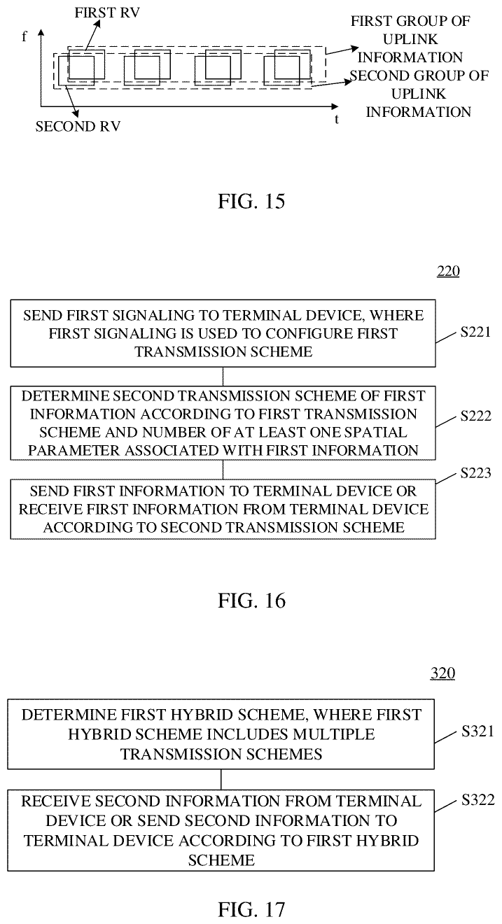

FIG. 15 illustrates another example of a mapping manner of a first hybrid scheme for an RV provided in embodiments of the disclosure.

As illustrated in FIG. 15, for a hybrid scheme of SDM scheme B and repetition type A, a hybrid scheme of SDM scheme B and repetition type B, or a hybrid scheme of an SFN scheme and repetition type A, the mapping manner of the first hybrid scheme for the RV may include the following. Different RV patterns are used for the first group of uplink information and the second group of uplink information. That is, the first RV is used for the first one of four uplink information associated with TCI state 1 (i.e., the first group of uplink information), and the second RV is used for the first one of four uplink information associated with TCI state 2 (i.e., the second group of uplink information). The first RV is different from the second RV.

It may be understood that, FIG. 14 and FIG. 15 merely illustrate examples of the disclosure and may not be construed as limiting the disclosure.

For example, in other alternative embodiments, in addition to a hybrid scheme of FDM scheme B and repetition type A or a hybrid scheme of FDM scheme B and repetition type B, and a hybrid scheme of SDM scheme B and repetition type A or a hybrid scheme of SDM scheme B and repetition type B, the mapping manner of the first hybrid scheme for the RV provided in FIG. 14 or FIG. 15 may also be applied to other schemes.

The wireless communication method 310 according to embodiments of the disclosure has been described in detail above with reference to FIG. 10 to FIG. 16 from the perspective of the terminal device. The wireless communication method 320 according to embodiments of the disclosure will be described below with reference to FIG. 17 from the perspective of the network device.

The wireless communication methods 210 and 310 according to embodiments of the disclosure have been described in detail above with reference to FIG. 8 to FIG. 15 from the perspective of the terminal device. The wireless communication methods 220 and 320 according to embodiments of the disclosure will be described below with reference to FIG. 16 and FIG. 17 from the perspective of the network device.

FIG. 16 is a schematic flowchart of a wireless communication method 220 provided in embodiments of the disclosure. The method 220 may be performed by the network device illustrated in FIG. 1.

As illustrated in FIG. 16, the method 220 may include the following.

At S221, first signaling is sent to a terminal device, where the first signaling is used to configure a first transmission scheme.

At S222, a second transmission scheme of first information is determined according to the first transmission scheme and the number of at least one spatial parameter associated with the first information.

At S223, the first information is sent to the terminal device or received from the terminal device according to the second transmission scheme.

In some embodiments, the first signaling indicates the first transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

In some embodiments, the candidate transmission schemes further include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes further include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the first signaling is used to configure different transmission schemes.

In some embodiments, the first signaling includes sub-signaling for configuring one of the following transmission schemes: FDM scheme A, FDM scheme B, SDM scheme A, SDM scheme B, and an SFN scheme. Alternatively, the first signaling includes sub-signaling for configuring one of the following transmission schemes: an FDM scheme, an SDM scheme, and an SFN scheme.

In some embodiments, the first signaling is not used to simultaneously configure at least two of the following transmission schemes: FDM scheme A, FDM scheme B, SDM scheme A, SDM scheme B, or an SFN scheme. Alternatively, the first signaling is not used to simultaneously configure at least two of the following transmission schemes: an FDM scheme, an SDM scheme, or an SFN scheme.

In some embodiments, operations at S222 may include the following. If the number of the at least one spatial parameter is a first preset number, the second transmission scheme is determined according to the first transmission scheme.

In some embodiments, the operations at S222 may include the following. If the first transmission scheme is an FDM scheme, a transmission scheme indicated by second signaling is determined as the second transmission scheme. Alternatively, if the first transmission scheme is an SDM scheme, a transmission scheme indicated by third signaling is determined as the second transmission scheme. Alternatively, if the first transmission scheme is a TDM scheme, a transmission scheme indicated by fourth signaling is determined as the second transmission scheme. Alternatively, if the first transmission scheme is FDM scheme A, FDM scheme B, SDM scheme A, SDM scheme B, an SFN scheme, repetition type A, or repetition type B, the first transmission scheme is determined as the second transmission scheme. The second signaling indicates FDM scheme A or FDM scheme B, the third signaling indicates SDM scheme A or SDM scheme B, and the fourth signaling indicates repetition type A or repetition type B.

In some embodiments, the first preset number is 2.

In some embodiments, if the number of the at least one spatial parameter is a second preset number, the second transmission scheme is to send the first information in at least one time-domain transmission occasion by using the second preset number of spatial parameters.

In some embodiments, if the first transmission scheme is a TDM scheme, repetition type A, or repetition type B, the second transmission scheme is to repeatedly send the first information in multiple time-domain transmission occasions by using the second preset number of spatial parameters.

In some embodiments, if the first transmission scheme is an FDM scheme, an SFN scheme, an SDM scheme, FDM scheme A, FDM scheme B, SDM scheme A, or SDM scheme B, the second transmission scheme is to send the first information in one time-domain transmission occasion by using the second preset number of spatial parameters.

In some embodiments, the second preset number is 1.

It may be understood that, for operations in the wireless communication method 220, reference can be made to corresponding operations in the wireless communication method 210 and related content involved, which will not be repeated herein for the sake of brevity.

FIG. 17 is a schematic flowchart of a wireless communication method 320 provided in embodiments of the disclosure. The method 320 may be performed by the network device illustrated in FIG. 1.

As illustrated in FIG. 17, the method 320 may include the following.

At S321, a first hybrid scheme is determined, where the first hybrid scheme includes multiple transmission schemes.

At S322, second information is received from a terminal device or sent to the terminal device according to the first hybrid scheme.

In some embodiments, the first hybrid scheme is any one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

In some embodiments, operations at S321 may include the following. Fifth signaling is sent to the terminal device. A transmission scheme configured by the fifth signaling is the first hybrid scheme, or the transmission scheme configured by the fifth signaling is used to determine the first hybrid scheme.

In some embodiments, If the transmission scheme configured by the fifth signaling is a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B, then the first hybrid scheme is the transmission scheme configured by the fifth signaling. If the transmission scheme configured by the fifth signaling is an FDM scheme or the transmission scheme configured by the fifth signaling is a hybrid scheme of an FDM scheme and a TDM scheme, then the first hybrid scheme is a hybrid scheme of a transmission scheme indicated by second signaling and a transmission scheme indicated by fourth signaling. Alternatively, if the transmission scheme configured by the fifth signaling is an SDM scheme or the transmission scheme configured by the fifth signaling is a hybrid scheme of an SDM scheme and a TDM scheme, then the first hybrid scheme is a hybrid scheme of a transmission scheme indicated by third signaling and the transmission scheme indicated by the fourth signaling. Alternatively, if the transmission scheme configured by the fifth signaling is FDM scheme A, FDM scheme B, SDM scheme A, SDM scheme B, or an SFN scheme, then the first hybrid scheme is a hybrid scheme of the transmission scheme configured by the fifth signaling and the transmission scheme indicated by the fourth signaling. The second signaling indicates FDM scheme A or FDM scheme B, the third signaling indicates SDM scheme A or SDM scheme B, and the fourth signaling indicates repetition type A or repetition type B.

In some embodiments, the fifth signaling is used to configure a transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

In some embodiments, the candidate transmission schemes include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the fifth signaling is used to configure different transmission schemes.

In some embodiments, the fifth signaling includes sub-signaling for configuring one of the following transmission schemes: FDM scheme A, FDM scheme B, SDM scheme A, SDM scheme B, and an SFN scheme. Alternatively, the fifth signaling includes sub-signaling for configuring one of the following transmission schemes: an FDM scheme, an SDM scheme, and an SFN scheme.

In some embodiments, the fifth signaling is not used to simultaneously configure at least two of: FDM scheme A, FDM scheme B, SDM scheme A, SDM scheme B, or an SFN scheme. Alternatively, the fifth signaling is not used to simultaneously configure two of the following schemes: an FDM scheme, an SDM scheme, or an SFN scheme.

In some embodiments, operations at S322 may include the following. If the number of at least one spatial parameter associated with the second information is a first preset number, the second information is received from the terminal device or sent to the terminal device according to the first hybrid scheme.

In some embodiments, the first preset number is 2.

In some embodiments, the method 320 may further include the following. If the number of the at least one spatial parameter is a second preset number, the second information repeatedly sent by the terminal device is received or the second information is sent repeatedly to the terminal device in multiple time-domain transmission occasions by using the second preset number of spatial parameters.

In some embodiments, the second information includes a first group of uplink information and a second group of uplink information. A mapping manner of the first hybrid scheme for a TCI state includes the following. The first group of uplink information and the second group of uplink information are sent in a same time-domain transmission occasion in an FDM or SDM or SFN manner. A same group of uplink information is sent in different time-domain transmission occasions in a TDM manner.

In some embodiments, a mapping manner of the first hybrid scheme for an RV includes the following. A preset number of RVs are cyclically used for uplink information sent in different time-domain transmission occasions. A same RV is used for uplink information associated with different TCI states that is sent in a same time-domain transmission occasion.

In some embodiments, the second information includes a first group of uplink information and a second group of uplink information. A mapping manner of the first hybrid scheme for an RV includes the following. A same RV pattern is used for the first group of uplink information and the second group of uplink information.

In some embodiments, both a first RV used for the first uplink information in the first group of uplink information and a second RV used for the first uplink information in the second group of uplink information are RVs indicated by DCI, and the first RV is the same as the second RV.

In some embodiments, both an ID of an RV used for n-th uplink information in the first group of uplink information and an ID of an RV used for n-th uplink information in the second group of uplink information are determined according to n and a first RV used for the first uplink information in the first group of uplink information.

In some embodiments, the mapping manner of the first hybrid scheme for the RV includes the following. A preset number of RVs are cyclically used for uplink information sent in different time-domain transmission occasions. Different RVs are used for uplink information associated with different TCI states that is sent in a same time-domain transmission occasion.

In some embodiments, the second information includes a first group of uplink information and a second group of uplink information. A mapping manner of the first hybrid scheme for an RV includes the following. Different RV patterns are used for the first group of uplink information and the second group of uplink information.

In some embodiments, a first group of RV patterns are used for the first group of uplink information, a second group of RV patterns are used for the second group of uplink information, and the second group of RV patterns have an RV offset relative to the first group of RV patterns.

In some embodiments, a first RV used for the first uplink information in the first group of uplink information is an RV indicated by DCI, and a second RV used for the first uplink information in the second group of uplink information is an RV offset from the first RV.

In some embodiments, an ID of an RV used for n-th uplink information in the first group of uplink information is determined according to an ID of the first RV and n. An ID of an RV used for n-th uplink information in the second group of uplink information is determined according to the ID of the first RV, an offset of the second RV relative to the first RV, and n.

In some embodiments, if the first group of uplink information and the second group of uplink information belong to a same codeword, the second RV is the RV offset from the first RV.

In some embodiments, both a first RV used for the first uplink information in the first group of uplink information and a second RV used for the first uplink information in the second group of uplink information are RVs indicated by DCI; and the first RV is different from the second RV.

In some embodiments, an ID of an RV used for n-th uplink information in the first group of uplink information is determined according to the first RV and n, and an ID of an RV used for n-th uplink information in the second group of uplink information is determined according to the second RV and n.

In some embodiments, if the first group of uplink information and the second group of uplink information belong to different codewords, both the first RV and the second RV are the RVs indicated by the DCI.

In some embodiments, the first group of uplink information is associated with a first TCI state, and the second group of uplink information is associated with a second TCI state.

In some embodiments, at least one uplink information associated with a second TCI state in the first group of uplink information exists between two adjacent uplink information associated with a first TCI state in the first group of uplink information; and at least one uplink information associated with the second TCI state in the second group of uplink information exists between two adjacent uplink information associated with the first TCI state in the second group of uplink information.

It may be understood that, for operations in the wireless communication method 320, reference can be made to corresponding operations in the wireless communication method 310, which will not be repeated herein for the sake of brevity.

The preferred embodiments of the disclosure have been described in detail above in connection with the accompanying drawings. However, the present disclosure is not limited to the details of the above embodiments. Various simple modifications can be made to the technical solution of the disclosure within the scope of the technical concept of the disclosure, and such simple modifications shall be within the protection scope of the present disclosure. For example, all the technical features described in the above embodiments can be combined with each other in any proper manner without conflict. In order to avoid unnecessary repetition, various manners of combination will not be elaborated in the disclosure. For another example, various embodiments of the disclosure can also be randomly combined without departing from the spirit of the present disclosure, and such combination should also be regarded as content disclosed by the present disclosure.

It may also be understood that, in various method embodiments of the disclosure, the magnitude of a sequence number of each of the foregoing processes does not mean an execution order, and an execution order of each process may be determined according to a function and an internal logic of the process, which shall not constitute any limitation to an implementation process of embodiments of the disclosure. In addition, in embodiments of the disclosure, the terms “downlink” and “uplink” indicate a transmission direction of a signal or data, where “downlink” indicates that a transmission direction of a signal or data is a first direction from a station to a UE in a cell, “uplink” indicates that a transmission direction of a signal or data is a second direction from a UE in a cell to a station. For example, a “downlink signal” indicates that a transmission direction of the signal is the first direction. Furthermore, in embodiments of the disclosure, the term “and/or” herein only describes an association relationship between associated objects, which means that there can be three relationships. Specifically, A and/or B can mean A alone, both A and B exist, and B alone. Besides, the character “/” herein generally indicates that the associated objects are in an “or” relationship.

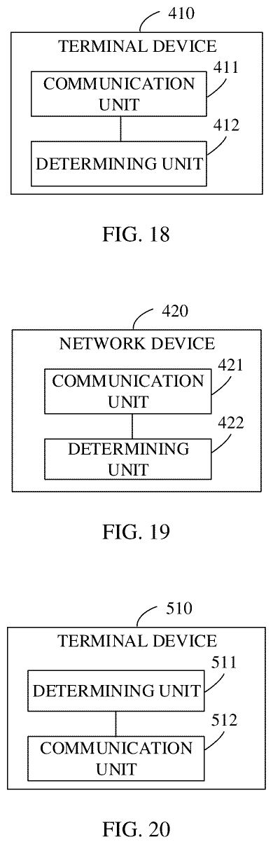

The method embodiments of the disclosure have been described in detail above with reference to FIG. 1 to FIG. 17, and the apparatus embodiments of the disclosure will be described in detail below with reference to FIG. 18 to FIG. 23.

FIG. 18 is a schematic block diagram of a terminal device 410 according to embodiments of the disclosure.

As illustrated in FIG. 18, the terminal device 410 may include a communication unit 411 and a determining unit 412. The communication unit 411 is configured to receive first signaling from a network device, where the first signaling is used to configure a first transmission scheme. The determining unit 412 is configured to determine a second transmission scheme of first information according to the first transmission scheme and the number of at least one spatial parameter associated with the first information. The communication unit 411 is further configured to send the first information to the network device or receive the first information from the network device according to the second transmission scheme.

In some embodiments, the first signaling indicates the first transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

In some embodiments, the candidate transmission schemes further include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes further include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the first signaling is used to configure different transmission schemes.

In some embodiments, the first signaling includes sub-signaling for configuring one of the following transmission schemes: FDM scheme A, FDM scheme B, SDM scheme A, SDM scheme B, and an SFN scheme. Alternatively, the first signaling includes sub-signaling for configuring one of the following transmission schemes: an FDM scheme, an SDM scheme, and an SFN scheme.

In some embodiments, the first signaling is not used to simultaneously configure at least two of the following transmission schemes: FDM scheme A, FDM scheme B, SDM scheme A, SDM scheme B, or an SFN scheme. Alternatively, the first signaling is not used to simultaneously configure at least two of the following transmission schemes: an FDM scheme, an SDM scheme, or an SFN scheme.

In some embodiments, the determining unit 412 is specifically configured to determine the second transmission scheme according to the first transmission scheme, if the number of the at least one spatial parameter is a first preset number.

In some embodiments, the determining unit 412 is specifically configured to determine a transmission scheme indicated by second signaling as the second transmission scheme, if the first transmission scheme is an FDM scheme. Alternatively, the determining unit 412 is specifically configured to determine a transmission scheme indicated by third signaling as the second transmission scheme, if the first transmission scheme is an SDM scheme. Alternatively, the determining unit 412 is specifically configured to determine a transmission scheme indicated by fourth signaling as the second transmission scheme, if the first transmission scheme is a TDM scheme. Alternatively, the determining unit 412 is specifically configured to determine the first transmission scheme as the second transmission scheme, if the first transmission scheme is FDM scheme A, FDM scheme B, SDM scheme A, SDM scheme B, an SFN scheme, repetition type A, or repetition type B. The second signaling indicates FDM scheme A or FDM scheme B, the third signaling indicates SDM scheme A or SDM scheme B, and the fourth signaling indicates repetition type A or repetition type B.

In some embodiments, the first preset number is 2.

In some embodiments, if the number of the at least one spatial parameter is a second preset number, the second transmission scheme is to send the first information in at least one time-domain transmission occasion by using the second preset number of spatial parameters.

In some embodiments, if the first transmission scheme is a TDM scheme, repetition type A, or repetition type B, the second transmission scheme is to repeatedly send the first information in multiple time-domain transmission occasions by using the second preset number of spatial parameters. Alternatively, if the first transmission scheme is an FDM scheme, an SFN scheme, an SDM scheme, FDM scheme A, FDM scheme B, SDM scheme A, or SDM scheme B, the second transmission scheme is to send the first information in one time-domain transmission occasion by using the second preset number of spatial parameters.

In some embodiments, the second preset number is 1.

It may be understood that, apparatus embodiments and method embodiments correspond to each other. For similar elaborations, reference can be made to the method embodiments. Specifically, the terminal device 410 illustrated in FIG. 18 may correspond to a corresponding entity for implementing the method 210 in embodiments of the disclosure, and the above and other operations and/or functions of various units of the terminal device 410 are respectively intended for implementing corresponding operations in the method 210 provided in embodiments of the disclosure, which will not be repeated herein for the sake of brevity.

FIG. 19 is a schematic block diagram of a network device 420 according to embodiments of the disclosure.

As illustrated in FIG. 19, the network device 420 may include a communication unit 421 and a determining unit 422. The communication unit 421 is configured to send first signaling to a terminal device, where the first signaling is used to configure a first transmission scheme. The determining unit 422 is configured to determine a second transmission scheme of first information according to the first transmission scheme and the number of at least one spatial parameter associated with the first information. The communication unit 421 is further configured to send the first information to the terminal device or receive the first information from the terminal device according to the second transmission scheme.

In some embodiments, the first signaling indicates the first transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

In some embodiments, the candidate transmission schemes further include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes further include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the first signaling is used to configure different transmission schemes.

In some embodiments, the first signaling includes sub-signaling for configuring one of the following transmission schemes: FDM scheme A, FDM scheme B, SDM scheme A, SDM scheme B, and an SFN scheme. Alternatively, the first signaling includes sub-signaling for configuring one of the following transmission schemes: an FDM scheme, an SDM scheme, and an SFN scheme.

In some embodiments, the first signaling is not used to simultaneously configure at least two of the following transmission schemes: FDM scheme A, FDM scheme B, SDM scheme A, SDM scheme B, or an SFN scheme. Alternatively, the first signaling is not used to simultaneously configure at least two of the following transmission schemes: an FDM scheme, an SDM scheme, or an SFN scheme.

In some embodiments, the determining unit 422 is specifically configured to determine the second transmission scheme according to the first transmission scheme, if the number of the at least one spatial parameter is a first preset number.

In some embodiments, the determining unit 422 is specifically configured to determine a transmission scheme indicated by second signaling as the second transmission scheme, if the first transmission scheme is an FDM scheme. Alternatively, the determining unit 422 is specifically configured to determine a transmission scheme indicated by third signaling as the second transmission scheme, if the first transmission scheme is an SDM scheme. Alternatively, the determining unit 422 is specifically configured to determine a transmission scheme indicated by fourth signaling as the second transmission scheme, if the first transmission scheme is a TDM scheme. Alternatively, the determining unit 422 is specifically configured to determine the first transmission scheme as the second transmission scheme, if the first transmission scheme is FDM scheme A, FDM scheme B, SDM scheme A, SDM scheme B, an SFN scheme, repetition type A, or repetition type B. The second signaling indicates FDM scheme A or FDM scheme B, the third signaling indicates SDM scheme A or SDM scheme B, and the fourth signaling indicates repetition type A or repetition type B.

In some embodiments, the first preset number is 2.

In some embodiments, if the number of the at least one spatial parameter is a second preset number, the second transmission scheme is to send the first information in at least one time-domain transmission occasion by using the second preset number of spatial parameters.

In some embodiments, if the first transmission scheme is a TDM scheme, repetition type A, or repetition type B, the second transmission scheme is to repeatedly send the first information in multiple time-domain transmission occasions by using the second preset number of spatial parameters. Alternatively, if the first transmission scheme is an FDM scheme, an SFN scheme, an SDM scheme, FDM scheme A, FDM scheme B, SDM scheme A, or SDM scheme B, the second transmission scheme is to send the first information in one time-domain transmission occasion by using the second preset number of spatial parameters.

In some embodiments, the second preset number is 1.

It may be understood that, apparatus embodiments and method embodiments correspond to each other. For similar elaborations, reference can be made to the method embodiments. Specifically, the terminal device 420 illustrated in FIG. 19 may correspond to a corresponding entity for implementing the method 220 in embodiments of the disclosure, and the above and other operations and/or functions of various units of the network device 420 are respectively intended for implementing corresponding operations in the method 220 provided in embodiments of the disclosure, which will not be repeated herein for the sake of brevity.

FIG. 20 is a schematic block diagram of a terminal device 510 according to embodiments of the disclosure.

As illustrated in FIG. 20, the terminal device 510 may include a determining unit 511 and a communication unit 512. The determining unit 511 is configured to determine a first hybrid scheme, where the first hybrid scheme includes multiple transmission schemes. The communication unit 512 is configured to send second information to a network device or receive the second information from the network device according to the first hybrid scheme.

In some embodiments, the first hybrid scheme is any one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

In some embodiments, the determining unit 511 is specifically configured to receive fifth signaling from the network device. The determining unit 511 is further configured to determine a transmission scheme configured by the fifth signaling as the first hybrid scheme, or determine the first hybrid scheme according to the transmission scheme configured by the fifth signaling.

In some embodiments, the determining unit 511 is specifically configured to determine the transmission scheme configured by the fifth signaling as the first hybrid scheme, if the transmission scheme configured by the fifth signaling is a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B. The determining unit 511 is specifically configured to determine a hybrid scheme of a transmission scheme indicated by second signaling and a transmission scheme indicated by fourth signaling as the first hybrid scheme, if the transmission scheme configured by the fifth signaling is an FDM scheme or the transmission scheme configured by the fifth signaling is a hybrid scheme of an FDM scheme and a TDM scheme. Alternatively, the determining unit 511 is specifically configured to determine a hybrid scheme of a transmission scheme indicated by third signaling and the transmission scheme indicated by the fourth signaling as the first hybrid scheme, if the transmission scheme configured by the fifth signaling is an SDM scheme or the transmission scheme configured by the fifth signaling is a hybrid scheme of an SDM scheme and a TDM scheme. Alternatively, the determining unit 511 is specifically configured to determine a hybrid scheme of the transmission scheme configured by the fifth signaling and the transmission scheme indicated by the fourth signaling as the first hybrid scheme, if the transmission scheme configured by the fifth signaling is FDM scheme A, FDM scheme B, SDM scheme A, SDM scheme B, or an SFN scheme. The second signaling indicates FDM scheme A or FDM scheme B, the third signaling indicates SDM scheme A or SDM scheme B, and the fourth signaling indicates repetition type A or repetition type B.

In some embodiments, the fifth signaling is used to configure a transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

In some embodiments, the candidate transmission schemes include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type

A, or a hybrid scheme of an SFN scheme and repetition type B.

In some embodiments, different sub-signaling in the fifth signaling is used to configure different transmission schemes.

In some embodiments, the fifth signaling includes sub-signaling for configuring one of the following transmission schemes: FDM scheme A, FDM scheme B, SDM scheme A, SDM scheme B, and an SFN scheme. Alternatively, the fifth signaling includes sub-signaling for configuring one of the following transmission schemes: an FDM scheme, an SDM scheme, and an SFN scheme.

In some embodiments, the fifth signaling is not used to simultaneously configure at least two of: FDM scheme A, FDM scheme B, SDM scheme A, SDM scheme B, or an SFN scheme. Alternatively, the fifth signaling is not used to simultaneously configure two of the following schemes: an FDM scheme, an SDM scheme, or an SFN scheme.

In some embodiments, the communication unit 512 is specifically configured to send the second information to the network device or receive the second information from the network device according to the first hybrid scheme, if the number of at least one spatial parameter associated with the second information is a first preset number.

In some embodiments, the first preset number is 2.

In some embodiments, the communication unit 512 is further configured to repeatedly send the second information to the network device or repeatedly receive the second information from the network device in multiple time-domain transmission occasions by using a second preset number of spatial parameters, if the number of the at least one spatial parameter is the second preset number.

In some embodiments, the second information includes a first group of uplink information and a second group of uplink information. A mapping manner of the first hybrid scheme for a TCI state includes the following. The first group of uplink information and the second group of uplink information are sent in a same time-domain transmission occasion in an FDM or SDM or SFN manner. A same group of uplink information is sent in different time-domain transmission occasions in a TDM manner.

In some embodiments, a mapping manner of the first hybrid scheme for an RV includes the following. A preset number of RVs are cyclically used for uplink information sent in different time-domain transmission occasions. A same RV is used for uplink information associated with different TCI states that is sent in a same time-domain transmission occasion.

In some embodiments, the second information includes a first group of uplink information and a second group of uplink information. A mapping manner of the first hybrid scheme for an RV includes the following. A same RV pattern is used for the first group of uplink information and the second group of uplink information.

In some embodiments, both a first RV used for the first uplink information in the first group of uplink information and a second RV used for the first uplink information in the second group of uplink information are RVs indicated by DCI; and the first RV is the same as the second RV.

In some embodiments, both an ID of an RV used for n-th uplink information in the first group of uplink information and an ID of an RV used for n-th uplink information in the second group of uplink information are determined according to n and a first RV used for the first uplink information in the first group of uplink information.

In some embodiments, a mapping manner of the first hybrid scheme for an RV includes the following. A preset number of RVs are cyclically used for uplink information sent in different time-domain transmission occasions. Different RVs are used for uplink information associated with different TCI states that is sent in a same time-domain transmission occasion.

In some embodiments, the second information includes a first group of uplink information and a second group of uplink information. A mapping manner of the first hybrid scheme for an RV includes the following. Different RV patterns are used for the first group of uplink information and the second group of uplink information.

In some embodiments, a first group of RV patterns are used for the first group of uplink information, a second group of RV patterns are used for the second group of uplink information, and the second group of RV patterns have an RV offset relative to the first group of RV patterns.

In some embodiments, a first RV used for the first uplink information in the first group of uplink information is an RV indicated by DCI, and a second RV used for the first uplink information in the second group of uplink information is an RV offset from the first RV.

In some embodiments, an ID of an RV used for n-th uplink information in the first group of uplink information is determined according to an ID of the first RV and n, and an ID of an RV used for n-th uplink information in the second group of uplink information is determined according to the ID of the first RV, an offset of the second RV relative to the first RV, and n.

In some embodiments, if the first group of uplink information and the second group of uplink information belong to a same codeword, the second RV is the RV offset from the first RV.

In some embodiments, both a first RV used for the first uplink information in the first group of uplink information and a second RV used for the first uplink information in the second group of uplink information are RVs indicated by DCI; and the first RV is different from the second RV.

In some embodiments, an ID of an RV used for n-th uplink information in the first group of uplink information is determined according to the first RV and n, and an ID of an RV used for n-th uplink information in the second group of uplink information is determined according to the second RV and n.

In some embodiments, if the first group of uplink information and the second group of uplink information belong to different codewords, both the first RV and the second RV are the RVs indicated by the DCI.

In some embodiments, the first group of uplink information is associated with a first TCI state, and the second group of uplink information is associated with a second TCI state.

In some embodiments, at least one uplink information associated with a second TCI state in the first group of uplink information exists between two adjacent uplink information associated with a first TCI state in the first group of uplink information. At least one uplink information associated with the second TCI state in the second group of uplink information exists between two adjacent uplink information associated with the first TCI state in the second group of uplink information.

It may be understood that, apparatus embodiments and method embodiments correspond to each other. For similar elaborations, reference can be made to the method embodiments. Specifically, the terminal device 510 illustrated in FIG. 20 may correspond to a corresponding entity for implementing the method 310 in embodiments of the disclosure, and the above and other operations and/or functions of various units of the terminal device 510 are respectively intended for implementing corresponding operations in the method 310 provided in embodiments of the disclosure, which will not be repeated herein for the sake of brevity.

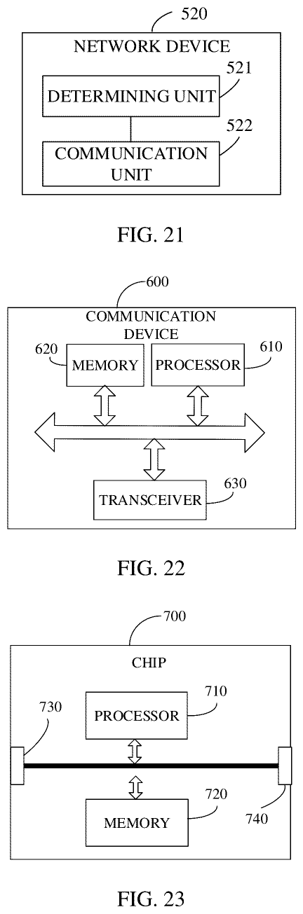

FIG. 21 is a schematic block diagram of a network device 520 according to embodiments of the disclosure.

As illustrated in FIG. 21, the network device 520 may include a determining unit 521 and a communication unit 522 The determining unit 521 is configured to determine a first hybrid scheme, where the first hybrid scheme includes multiple transmission schemes. The communication unit 522 is configured to receive second information from a terminal device or send the second information to the terminal device according to the first hybrid scheme.

In some embodiments, the first hybrid scheme is any one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, and a hybrid scheme of an SFN scheme and repetition type B.

In some embodiments, the communication unit 522 is further configured to send fifth signaling to the terminal device. A transmission scheme configured by the fifth signaling is the first hybrid scheme, or the transmission scheme configured by the fifth signaling is used to determine the first hybrid scheme.

In some embodiments, if the transmission scheme configured by the fifth signaling is a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B, then the first hybrid scheme is the transmission scheme configured by the fifth signaling. If the transmission scheme configured by the fifth signaling is an FDM scheme or the transmission scheme configured by the fifth signaling is a hybrid scheme of an FDM scheme and a TDM scheme, then the first hybrid scheme is a hybrid scheme of a transmission scheme indicated by second signaling and a transmission scheme indicated by fourth signaling. Alternatively, if the transmission scheme configured by the fifth signaling is an SDM scheme or the transmission scheme configured by the fifth signaling is a hybrid scheme of an SDM scheme and a TDM scheme, then the first hybrid scheme is a hybrid scheme of a transmission scheme indicated by third signaling and the transmission scheme indicated by the fourth signaling. Alternatively, if the transmission scheme configured by the fifth signaling is FDM scheme A, FDM scheme B, SDM scheme A, SDM scheme B, or an SFN scheme, then the first hybrid scheme is a hybrid scheme of the transmission scheme configured by the fifth signaling and the transmission scheme indicated by the fourth signaling. The second signaling indicates FDM scheme A or FDM scheme B, the third signaling indicates SDM scheme A or SDM scheme B, and the fourth signaling indicates repetition type A or repetition type B.

In some embodiments, the fifth signaling is used to configure a transmission scheme among candidate transmission schemes.

In some embodiments, the candidate transmission schemes include at least one of: FDM scheme A, FDM scheme B, SDM scheme A, SDM scheme B, an SFN scheme, repetition type A, or repetition type B. Alternatively, the candidate transmission schemes include at least one of: an FDM scheme, an SDM scheme, a TDM scheme, or an SFN scheme.

In some embodiments, the candidate transmission schemes include at least one of: a hybrid scheme of an FDM scheme and a TDM scheme, a hybrid scheme of an SDM scheme and a TDM scheme, or a hybrid scheme of an SFN scheme and a TDM scheme. Alternatively, the candidate transmission schemes include at least one of: a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B.

In some embodiments, different sub-signaling in the fifth signaling is used to configure different transmission schemes.

In some embodiments, the fifth signaling includes sub-signaling for configuring one of the following transmission schemes: FDM scheme A, FDM scheme B, SDM scheme A, SDM scheme B, and an SFN scheme. Alternatively, the fifth signaling includes sub-signaling for configuring one of the following transmission schemes: an FDM scheme, an SDM scheme, and an SFN scheme.

In some embodiments, the fifth signaling is not used to simultaneously configure at least two of: FDM scheme A, FDM scheme B, SDM scheme A, SDM scheme B, or an SFN scheme. Alternatively, the fifth signaling is not used to simultaneously configure two of the following schemes: an FDM scheme, an SDM scheme, or an SFN scheme.

In some embodiments, the communication unit 522 is specifically configured to receive the second information from the terminal device or send the second information to the terminal device according to the first hybrid scheme, if the number of at least one spatial parameter associated with the second information is a first preset number.

In some embodiments, the first preset number is 2.

In some embodiments, the communication unit 522 is further configured to receive the second information repeatedly sent by the terminal device or repeatedly send the second information to the terminal device in multiple time-domain transmission occasions by using a second preset number of spatial parameters, if the number of the at least one spatial parameter is the second preset number.

In some embodiments, the second information includes a first group of uplink information and a second group of uplink information. A mapping manner of the first hybrid scheme for a TCI state includes the following. The first group of uplink information and the second group of uplink information are sent in a same time-domain transmission occasion in an FDM or SDM or SFN manner. A same group of uplink information is sent in different time-domain transmission occasions in a TDM manner.

In some embodiments, a mapping manner of the first hybrid scheme for an RV includes the following. A preset number of RVs are cyclically used for uplink information sent in different time-domain transmission occasions. A same RV is used for uplink information associated with different TCI states that is sent in a same time-domain transmission occasion.

In some embodiments, the second information includes a first group of uplink information and a second group of uplink information. A mapping manner of the first hybrid scheme for an RV includes the following. A same RV pattern is used for the first group of uplink information and the second group of uplink information.

In some embodiments, both a first RV used for the first uplink information in the first group of uplink information and a second RV used for the first uplink information in the second group of uplink information are RVs indicated by DCI, and the first RV is the same as the second RV.

In some embodiments, both an ID of an RV used for n-th uplink information in the first group of uplink information and an ID of an RV used for n-th uplink information in the second group of uplink information are determined according to n and a first RV used for the first uplink information in the first group of uplink information.

In some embodiments, the mapping manner of the first hybrid scheme for the RV includes the following. A preset number of RVs are cyclically used for uplink information sent in different time-domain transmission occasions. Different RVs are used for uplink information associated with different TCI states that is sent in a same time-domain transmission occasion.

In some embodiments, the second information includes a first group of uplink information and a second group of uplink information. A mapping manner of the first hybrid scheme for an RV includes the following. Different RV patterns are used for the first group of uplink information and the second group of uplink information.

In some embodiments, a first group of RV patterns are used for the first group of uplink information, a second group of RV patterns are used for the second group of uplink information, and the second group of RV patterns have an RV offset relative to the first group of RV patterns.

In some embodiments, a first RV used for the first uplink information in the first group of uplink information is an RV indicated by DCI, and a second RV used for the first uplink information in the second group of uplink information is an RV offset from the first RV.

In some embodiments, an ID of an RV used for n-th uplink information in the first group of uplink information is determined according to an ID of the first RV and n. An ID of an RV used for n-th uplink information in the second group of uplink information is determined according to the ID of the first RV, an offset of the second RV relative to the first RV, and n.

In some embodiments, if the first group of uplink information and the second group of uplink information belong to a same codeword, the second RV is the RV offset from the first RV.

In some embodiments, both a first RV used for the first uplink information in the first group of uplink information and a second RV used for the first uplink information in the second group of uplink information are RVs indicated by DCI; and the first RV is different from the second RV.

In some embodiments, an ID of an RV used for n-th uplink information in the first group of uplink information is determined according to the first RV and n, and an ID of an RV used for n-th uplink information in the second group of uplink information is determined according to the second RV and n.

In some embodiments, if the first group of uplink information and the second group of uplink information belong to different codewords, both the first RV and the second RV are the RVs indicated by the DCI.

In some embodiments, the first group of uplink information is associated with a first TCI state, and the second group of uplink information is associated with a second TCI state.

In some embodiments, at least one uplink information associated with a second TCI state in the first group of uplink information exists between two adjacent uplink information associated with a first TCI state in the first group of uplink information. At least one uplink information associated with the second TCI state in the second group of uplink information exists between two adjacent uplink information associated with the first TCI state in the second group of uplink information.

It may be understood that, apparatus embodiments and method embodiments correspond to each other. For similar elaborations, reference can be made to the method embodiments. Specifically, the network device 520 illustrated in FIG. 21 may correspond to a corresponding entity for implementing the method 320 in embodiments of the disclosure, and the above and other operations and/or functions of various units of the network device 520 are respectively intended for implementing corresponding operations in the method 320 provided in embodiments of the disclosure, which will not be repeated herein for the sake of brevity.

The communication device in embodiments of the disclosure has been described above from the perspective of functional modules with reference to the accompanying drawings. It may be understood that, the functional module may be implemented in the form of hardware, or may be implemented by an instruction in the form of software, or may be implemented by a combination of hardware and software module. Specifically, each step of the method embodiments of the disclosure may be completed by an integrated logic circuit of hardware in a processor and/or an instruction in the form of software. The steps of the method disclosed in embodiments of the disclosure may be directly implemented by a hardware decoding processor, or may be performed by hardware and software modules in the decoding processor. Optionally, the software module can be located in a storage medium such as a random access memory (RAM), a flash memory, a read only memory (ROM), a programmable ROM (PROM), or an electrically erasable programmable memory, registers, and the like. The storage medium is located in a memory. The processor reads the information in the memory, and completes the steps of the foregoing method embodiments with the hardware of the processor.

For example, the processing unit described above may be implemented by a processor, and the communication unit described above may be implemented by a transceiver.

FIG. 22 is a schematic structural diagram of a communication device 600 according to embodiments of the disclosure.

As illustrated in FIG. 22, the communication device 600 may include a processor 610.

The processor 610 may invoke and execute a computer program from a memory, so as to implement the method in embodiments of the disclosure.

As illustrated in FIG. 22, the communication device 600 may further include a memory 620.

The memory 620 may be configured to store indication information, or store codes, instructions, etc. executable by the processor 610. The processor 610 can invoke and execute a computer program stored in the memory 620, to implement the method in embodiments of the disclosure. The memory 620 may be a separate device independent of the processor 610, or may be integrated into the processor 610.

As illustrated in FIG. 22, the communication device 600 may further include a transceiver 630.

The processor 610 can control the transceiver 630 to communicate with other devices, specifically, to send information or data to other devices or to receive information or data sent by other devices. The transceiver 630 may include a transmitter and a receiver. The transceiver 630 may further include an antenna, where one or more antennas can be provided.

It may be understood that, various components in the communication device 600 are connected together via a bus system. In addition to a data bus, the bus system may further include a power bus, a control bus, and a status signal bus.

It may also be understood that, the communication device 600 may be operable as the terminal device in embodiments of the disclosure, and the communication device 600 can implement the operations performed by the terminal device in various methods in embodiments of the disclosure. In other words, the communication device 600 in embodiments of the disclosure can correspond to the terminal device 410 or the terminal device 510 in embodiments of the disclosure, and can correspond to a corresponding entity for implementing the method 210 or 310 according to embodiments of the disclosure, which will not be repeated herein for the sake of brevity. Similarly, the communication device 600 may be operable as the network device in embodiments of the disclosure, and the communication device 600 can implement the operations performed by the network device in various methods in embodiments of the disclosure. In other words, the communication device 600 in embodiments of the disclosure can correspond to the network device 420 or the network device 520 in embodiments of the disclosure, and can correspond to a corresponding entity for implementing the method 220 or 320 according to embodiments of the disclosure, which will not be repeated herein for the sake of brevity.

In addition, a chip is further provided in embodiments of the disclosure.

For example, the chip may be an integrated circuit chip with signal processing capabilities, which can implement or execute various methods, steps, or logic blocks disclosed in embodiments of the disclosure. The chip may also be referred to as an SOC. Optionally, the chip is applicable to various communication devices, to cause a communication device equipped with the chip to perform various methods, steps, or logic blocks disclosed in embodiments of the disclosure.

FIG. 23 is a schematic structural diagram of a chip 700 according to embodiments of the disclosure.

As illustrated in FIG. 23, the chip 700 includes a processor 710.

The processor 710 may invoke and execute a computer program from a memory, so as to implement the method in embodiments of the disclosure.

As illustrated in FIG. 23, the chip 700 may further include a memory 720.

The processor 710 can invoke and execute a computer program stored in the memory 720 to perform the method in embodiments of the disclosure. The memory 720 can be configured to store indication information, or store codes, instructions, etc. executable by the processor 710. The memory 720 may be a separate device independent of the processor 710, or may be integrated into the processor 710.

As illustrated in FIG. 23, the chip 70 may further include an input interface 730.

The processor 710 may control the input interface 730 to communicate with other devices or chips, and specifically, may obtain information or data sent by other devices or chips. As illustrated in FIG. 23, the chip 700 may further include an output interface 740.

The processor 710 may control the output interface 740 to communicate with other devices or chips, and specifically, may output information or data to other devices or chips.

It may be understood that, the chip 700 may be applied to the network device in embodiments of the disclosure, and the chip may implement corresponding operations implemented by the network device in various methods in embodiments of the disclosure, or may implement corresponding operations implemented by the terminal device in various methods in embodiments of the disclosure, which will not be repeated herein for the sake of brevity.

It may also be understood that, various components in the chip 700 are connected together via a bus system. In addition to a data bus, the bus system may further include a power bus, a control bus, and a status signal bus.

The processor described above may include but is not limited to: a general-purpose processor, a digital signal processor (DSP), an application specific integrated circuit (ASIC), a field programmable gate array (FPGA), or other programmable logic devices, discrete gates or transistor logic devices, discrete hardware components, etc.

The processor can be configured to perform or execute the methods, steps, and logic blocks disclosed in embodiments of the disclosure. The steps of the method disclosed in embodiments of the disclosure may be directly implemented by a hardware decoding processor, or may be performed by hardware and software modules in the decoding processor. The software module can be located in a storage medium such as a RAM, a flash memory, a ROM, a PROM, or an erasable programmable memory, registers, and the like. The storage medium is located in the memory. The processor reads the information in the memory, and completes the steps of the method described above with the hardware of the processor.

The memory described above may include but is not limited to a volatile memory and/or a non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

It may be noted that, the memory described in the disclosure is intended to include, but is not limited to, these and any other suitable types of memory.

A computer-readable storage medium is further provided in embodiments of the disclosure. The computer-readable storage medium is configured to store a computer program. The computer-readable storage medium stores one or more programs. The one or more programs include instructions which, when executed by a portable electronic device including multiple application programs, cause the portable electronic device to perform the wireless communication method provided in the disclosure. Optionally, the computer-readable storage medium is applicable to the network device of embodiments of the disclosure. The computer program causes a computer to implement the operations performed by the network device in various methods in embodiments of the disclosure, which will not be repeated herein for the sake of brevity. Optionally, the computer-readable storage medium is applicable to the mobile terminal/terminal device of embodiments of the disclosure. The computer program causes a computer to implement the operations performed by the mobile terminal/terminal device in various methods in embodiments of the disclosure, which will not be repeated herein for the sake of brevity.

A computer program product is further provided in embodiments of the disclosure. The computer program product includes a computer program. Optionally, the computer program product is applicable to the network device of embodiments of the disclosure. The computer program causes a computer to implement the operations performed by the network device in various methods in embodiments of the disclosure, which will not be repeated herein for the sake of brevity. Optionally, the computer program product is applicable to the mobile terminal/terminal device of embodiments of the disclosure. The computer program causes a computer to implement the operations performed by the mobile terminal/terminal device in various methods in embodiments of the disclosure, which will not be repeated herein for the sake of brevity.

A computer program is further provided in embodiments of the disclosure. The computer program, when executed by a computer, causes the computer to perform wireless communication method provided in the disclosure. Optionally, the computer program is applicable to the network device of embodiments of the disclosure. The computer program, when executed by a computer, causes the computer to implement the operations performed by the network device in various methods in embodiments of the disclosure, which will not be repeated herein for the sake of brevity. Optionally, the computer program is applicable to the mobile terminal/terminal device of embodiments of the disclosure. The computer program, when executed by a computer, causes the computer to implement the operations performed by the mobile terminal/terminal device in various methods in embodiments of the disclosure, which will not be repeated herein for the sake of brevity.

A communication system is further provided in embodiments of the disclosure. The communication system may include the terminal device and the network device described above, to constitute the communication system 100 illustrated in FIG. 1, which will not be repeated herein for the sake of brevity. It may be noted that, the term “system” or the like in the disclosure may also be referred to as “network management architecture” or “network system”, etc.

It may be also understood that, the terms used in embodiments of the disclosure and the appended claims are merely intended for describing the embodiments, rather than limiting embodiments of the disclosure. For example, the singular forms “a/an”, “said”, “the above”, and “the” used in embodiments of the disclosure and the appended claims are also intended to include multiple forms, unless specified otherwise in the context.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure. If the functions are implemented as software functional units and sold or used as standalone products, they may be stored in a computer-readable storage medium. Based on such an understanding, the essential technical solution, or the portion that contributes to the related art, or part of the technical solution of the disclosure may be embodied as software products. The computer software products can be stored in a storage medium and may include multiple instructions that, when executed, can cause a computing device, e.g., a personal computer, a server, a network device, etc., to execute some or all operations of the methods described in embodiments of the disclosure. The above storage medium may include various kinds of media that can store program codes, such as a universal serial bus (USB) flash disk, a mobile hard drive, a ROM, a RAM, a magnetic disk, or an optical disk.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein. It will be appreciated that the systems, apparatuses, and methods disclosed in embodiments of the disclosure may also be implemented in various other manners. For example, the division of units, modules, or assemblies in the foregoing apparatus embodiments is only a division of logical functions, and other manners of division may be available in practice, e.g., multiple units, modules, or assemblies may be combined or may be integrated into another system, or some features may be ignored or skipped. Separated units/modules/assemblies as illustrated may or may not be physically separated, that is, may reside at one location or may be distributed to multiple networked units. Some or all of the units/modules/assemblies may be selectively adopted according to practical needs to achieve desired objectives of the disclosure. It may be noted that, the coupling or direct coupling or communication connection as illustrated or discussed may be an indirect coupling or communication connection through some interface, device, or unit, and may be electrical, mechanical, or otherwise.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A wireless communication method, comprising:
receiving first signaling from a network device, wherein the first signaling is used to configure a first transmission scheme;
determining a second transmission scheme of first information according to the first transmission scheme and a number of at least one spatial parameter associated with the first information; and
sending the first information to the network device or receiving the first information from the network device according to the second transmission scheme.

2. The method of claim 1, wherein the first signaling indicates the first transmission scheme among candidate transmission schemes.

3. The method of claim 2, wherein
the candidate transmission schemes comprise at least one of: frequency division multiplexing (FDM) scheme A, FDM scheme B, spatial division multiplexing (SDM) scheme A, SDM scheme B, a single frequency network (SFN) scheme, repetition type A, or repetition type B; or
the candidate transmission schemes comprise at least one of: an FDM scheme, an SDM scheme, a time division multiplexing (TDM) scheme, or an SFN scheme.

4. The method of claim 1, wherein determining the second transmission scheme of the first information according to the first transmission scheme and the number of the at least one spatial parameter associated with the first information comprises:
determining the second transmission scheme according to the first transmission scheme, in response to the number of the at least one spatial parameter being a first preset number.

5. The method of claim 1, wherein in response to the number of the at least one spatial parameter being a second preset number, the second transmission scheme is to send the first information in at least one time-domain transmission occasion by using the second preset number of spatial parameters.

6. The method of claim 5, wherein in response to the first transmission scheme being a TDM scheme, repetition type A, or repetition type B, the second transmission scheme is to repeatedly send the first information in a plurality of time-domain transmission occasions by using the second preset number of spatial parameters; or
in response to the first transmission scheme being an FDM scheme, an SFN scheme, an SDM scheme, FDM scheme A, FDM scheme B, SDM scheme A, or SDM scheme B, the second transmission scheme is to send the first information in one time-domain transmission occasion by using the second preset number of spatial parameters.

7. The method of claim 5, wherein the second preset number is 1.

8. A wireless communication method, comprising:
determining a first hybrid scheme, wherein the first hybrid scheme comprises a plurality of transmission schemes; and
sending second information to a network device or receiving the second information from the network device according to the first hybrid scheme.

9. The method of claim 8, wherein the first hybrid scheme is any one of: a hybrid scheme of frequency division multiplexing (FDM) scheme A and repetition type A, a hybrid scheme of FDM scheme A and repetition type B, a hybrid scheme of FDM scheme B and repetition type A, a hybrid scheme of FDM scheme B and repetition type B, a hybrid scheme of spatial division multiplexing (SDM) scheme A and repetition type A, a hybrid scheme of SDM scheme A and repetition type B, a hybrid scheme of SDM scheme B and repetition type A, a hybrid scheme of SDM scheme B and repetition type B, a hybrid scheme of a single frequency network (SFN) scheme and repetition type A, and a hybrid scheme of an SFN scheme and repetition type B.

10. The method of claim 8, wherein determining the first hybrid scheme comprises:
receiving fifth signaling from the network device; and
determining a transmission scheme configured by the fifth signaling as the first hybrid scheme, or determining the first hybrid scheme according to the transmission scheme configured by the fifth signaling.

11. The method of claim 10, wherein determining the transmission scheme configured by the fifth signaling as the first hybrid scheme, or determining the first hybrid scheme according to the transmission scheme configured by the fifth signaling comprises:
determining the transmission scheme configured by the fifth signaling as the first hybrid scheme, in response to the transmission scheme configured by the fifth signaling being a hybrid scheme of FDM scheme A and repetition type A, a hybrid scheme of FDM scheme A and repetition type B, a hybrid scheme of FDM scheme B and repetition type A, a hybrid scheme of FDM scheme B and repetition type B, a hybrid scheme of SDM scheme A and repetition type A, a hybrid scheme of SDM scheme A and repetition type B, a hybrid scheme of SDM scheme B and repetition type A, a hybrid scheme of SDM scheme B and repetition type B, a hybrid scheme of an SFN scheme and repetition type A, or a hybrid scheme of an SFN scheme and repetition type B;
determining a hybrid scheme of a transmission scheme indicated by second signaling and a transmission scheme indicated by fourth signaling as the first hybrid scheme, in response to the transmission scheme configured by the fifth signaling being an FDM scheme or the transmission scheme configured by the fifth signaling being a hybrid scheme of an FDM scheme and a time division multiplexing (TDM) scheme; or
determining a hybrid scheme of a transmission scheme indicated by third signaling and the transmission scheme indicated by the fourth signaling as the first hybrid scheme, in response to the transmission scheme configured by the fifth signaling being an SDM scheme or the transmission scheme configured by the fifth signaling being a hybrid scheme of an SDM scheme and a TDM scheme; or
determining a hybrid scheme of the transmission scheme configured by the fifth signaling and the transmission scheme indicated by the fourth signaling as the first hybrid scheme, in response to the transmission scheme configured by the fifth signaling being FDM scheme A, FDM scheme B, SDM scheme A, SDM scheme B, or an SFN scheme, wherein
the second signaling indicates FDM scheme A or FDM scheme B, the third signaling indicates SDM scheme A or SDM scheme B, and the fourth signaling indicates repetition type A or repetition type B.

12. A terminal device, comprising:
a processor, a transceiver, and a memory, wherein the memory is configured to store a computer program, and the processor is configured to invoke and execute the computer program stored in the memory to cause the processor and the transceiver to:
receive first signaling from a network device, wherein the first signaling is used to configure a first transmission scheme;
determine a second transmission scheme of first information according to the first transmission scheme and a number of at least one spatial parameter associated with the first information; and
send the first information to the network device or receiving the first information from the network device according to the second transmission scheme.

13. The terminal device of claim 12, wherein the first signaling indicates the first transmission scheme among candidate transmission schemes.

14. The terminal device of claim 13, wherein
the candidate transmission schemes comprise at least one of: frequency division multiplexing (FDM) scheme A, FDM scheme B, spatial division multiplexing (SDM) scheme A, SDM scheme B, a single frequency network (SFN) scheme, repetition type A, or repetition type B; or
the candidate transmission schemes comprise at least one of: an FDM scheme, an SDM scheme, a time division multiplexing (TDM) scheme, or an SFN scheme.

15. The terminal device of claim 12, wherein in terms of determining the second transmission scheme of the first information according to the first transmission scheme and the number of the at least one spatial parameter associated with the first information, the processor is configured to invoke and execute the computer program stored in the memory to cause the processor to:
determine the second transmission scheme according to the first transmission scheme, in response to the number of the at least one spatial parameter being a first preset number.

16. The terminal device of claim 12, wherein in response to the number of the at least one spatial parameter being a second preset number, the second transmission scheme is to send the first information in at least one time-domain transmission occasion by using the second preset number of spatial parameters.

17. The terminal device of claim 16, wherein in response to the first transmission scheme being a TDM scheme, repetition type A, or repetition type B, the second transmission scheme is to repeatedly send the first information in a plurality of time-domain transmission occasions by using the second preset number of spatial parameters; or
in response to the first transmission scheme being an FDM scheme, an SFN scheme, an SDM scheme, FDM scheme A, FDM scheme B, SDM scheme A, or SDM scheme B, the second transmission scheme is to send the first information in one time-domain transmission occasion by using the second preset number of spatial parameters.

18. The method of claim 16, wherein the second preset number is 1.

19. A non-transitory computer-readable storage medium configured to store a computer program, wherein the computer program causes a computer to perform the method of claim 1.

20. A terminal device, comprising:
a processor, a transceiver, and a memory, wherein the memory is configured to store a computer program, and the processor is configured to invoke and execute the computer program stored in the memory to cause the processor and the transceiver to perform the method of claim 12.
